(19) United States
(12) Patent Application Publication
(10) Pub. No.: US 2023/0082162 A1
(43) Pub. Date: Mar. 16, 2023

(54) ATTACHMENT AND EARTH AUGER

(71) Applicant: MAKITA CORPORATION, Anjo-shi (JP)

(72) Inventors: Hidenori NAGASAKA, Anjo-shi (JP); Tomohiko IMAE, Anjo-shi (JP); Taisei OSAWA, Anjo-shi (JP)

(73) Assignee: MAKITA CORPORATION, Anjo-shi (JP)

(21) Appl. No.: 17/880,786

(22) Filed: Aug. 4, 2022

(30) Foreign Application Priority Data
Sep. 10, 2021 (JP) 2021-148092

(51) Int. Cl. B25F 5/02; B23B 45/00

(52) U.S. Cl. CPC B25F 5/026; B23B 45/001

(57) ABSTRACT

A drilling operation is assisted to form an intended hole in a drill target. An attachment is attachable to an earth auger. The earth auger includes a motor housing accommodating a motor, a handle housing located behind the motor housing and including a grip portion receiving a trigger switch operable to activate the motor, a gear housing located in front of the motor housing and accommodating a gear, and a rotation output unit protruding downward from the gear housing to receive a drill bit. The attachment includes an auxiliary pole to be located adjacent to the drill bit and extendable in a vertical direction.

### CROSS-REFERENCE TO RELATED APPLICATIONS

This application claims the benefit of priority to Japanese Patent Application No. 2021-148092, filed on Sep. 10, 2021, the entire contents of which are hereby incorporated by reference.

### BACKGROUND

### 1. Technical Field

The present disclosure relates to an attachment and an earth auger.

### 2. Description of the Background

In the field of earth augers, a power tool including an earth auger drill bit that is rotatable to drill into the ground is known as described in Japanese Unexamined Patent Application Publication No. 2020-196098 (Patent Literature 1). The power tool described in Patent Literature 1 is held by an operator while rotating the earth auger drill bit to form a hole in the ground.

### BRIEF SUMMARY

The earth auger held by the operator while drilling into a drill target may fail to form an intended hole in the drill target. A technique is awaited for assisting the drilling operation in forming an intended hole in the drill target.

One or more aspects of the present disclosure are directed to a technique for assisting a drilling operation in forming an intended hole in a drill target with a portable earth auger.

A first aspect of the present disclosure provides an attachment attachable to an earth auger, the earth auger including

a motor housing accommodating a motor,

a handle housing behind the motor housing, the handle housing including a grip portion receiving a trigger switch operable to activate the motor,

a gear housing in front of the motor housing, the gear housing accommodating a gear, and

a rotation output unit protruding downward from the gear housing to receive a drill bit,

the attachment including:

an auxiliary pole to be located adjacent to the drill bit and extendable in a vertical direction.

A second aspect of the present disclosure provides an attachment attachable to an earth auger, the earth auger including

a motor housing accommodating a motor,

a handle housing behind the motor housing, the handle housing including a grip portion receiving a trigger switch operable to activate the motor,

a gear housing in front of the motor housing, the gear housing accommodating a gear, and

a rotation output unit protruding downward from the gear housing to receive a drill bit,

the attachment including:

an auxiliary plate to be located on at least one of a left or a right of the gear housing to receive a reaction force transmitted from the rotation output unit to the gear housing.

A third aspect of the present disclosure provides an earth auger, including:

a motor housing accommodating a motor;

a handle housing behind the motor housing, the handle housing including a grip portion receiving a trigger switch);

a gear housing in front of the motor housing, the gear housing accommodating a gear;

a rotation output unit protruding downward from the gear housing to receive a drill bit; and

an attachment.

A fourth aspect of the present disclosure provides an earth auger, including:

a motor housing accommodating a motor;

a first grip on a left of the motor housing;

a second grip on a right of the motor housing;

a trigger switch operable to activate the motor;

a gear housing connected to the motor housing, the gear housing accommodating a gear;

a rotation output unit protruding downward from the gear housing to receive a drill bit; and

an auxiliary pole to be located adjacent to the drill bit and extendable in a vertical direction.

In the fourth aspect, the auxiliary pole may be located on the left or right of the rotation output unit. The auxiliary pole may be movable in the vertical direction. The auxiliary pole may be fastened at a predetermined position in the vertical direction.

The auxiliary pole may be attached to at least one of the motor housing or the gear housing.

A fifth aspect of the present disclosure provides an earth auger, including:

a motor housing accommodating a motor;

a first grip on a left of the motor housing;

a second grip on a right of the motor housing:

a trigger switch operable to activate the motor:

a gear housing connected to the motor housing, the gear housing accommodating a gear;

a rotation output unit protruding downward from the gear housing to receive a drill bit; and an auxiliary plate attached to at least one of the motor housing or the gear housing to receive a reaction force generated by rotation of the rotation output unit with an operator's body.

The structure according to the above aspects of the present disclosure assists a drilling operation in forming an intended hole in a drill target.

### BRIEF DESCRIPTION OF DRAWINGS

FIG. 1 is a front perspective view of an earth auger according to a first embodiment.

FIG. 2 is a rear perspective view of the earth auger according to the first embodiment.

FIG. 3 is a side view of the earth auger according to the first embodiment.

FIG. 4 is a sectional view of the earth auger according to the first embodiment.

FIG. 5 is an exploded front perspective view of parts of an attachment according to the first embodiment.

FIG. 6 is an exploded rear perspective view of the parts of the attachment according to the first embodiment.

FIG. 7 is a front perspective view of the parts of the attachment according to the first embodiment.

FIG. 8 is a rear perspective view of the parts of the attachment according to the first embodiment.

FIG. 9 is a front perspective view of the earth auger with a part of the attachment according to the first embodiment being attached.

FIG. 10 is a rear perspective view of the earth auger with the part of the attachment according to the first embodiment being attached.

FIG. 11 is a front perspective view of the earth auger with parts of the attachment according to the first embodiment being attached.

FIG. 12 is a rear perspective view of the earth auger with the parts of the attachment according to the first embodiment being attached.

FIG. 13 is a front perspective view of the earth auger with the attachment according to the first embodiment.

FIG. 14 is a rear perspective view of the earth auger with the attachment according to the first embodiment.

FIG. 15 is a left side view of the earth auger with the attachment according to the first embodiment.

FIG. 16 is a right side view of the earth auger with the attachment according to the first embodiment.

FIG. 17 is a top view of the earth auger with the attachment according to the first embodiment.

FIG. 18 is a bottom view of the earth auger with the attachment according to the first embodiment.

FIG. 19 is a rear view of the earth auger with the attachment according to the first embodiment.

FIG. 20 is a front view of the earth auger with the attachment according to the first embodiment.

FIG. 21 is an exploded perspective view of an auxiliary pole in the first embodiment.

FIG. 22 is a perspective view of the auxiliary pole and a retainer in the first embodiment.

FIG. 23 is a side view of the earth auger with the attachment according to the first embodiment, describing its use.

FIG. 24 is a plan view of the earth auger with the attachment according to the first embodiment, describing its use.

FIG. 25 is a front perspective view of the earth auger with an attachment according to a second embodiment.

FIG. 26 is a rear perspective view of the earth auger with the attachment according to the second embodiment.

FIG. 27 is a left side view of the earth auger with the attachment according to the second embodiment.

FIG. 28 is a right side view of the earth auger with the attachment according to the second embodiment.

FIG. 29 is a top view of the earth auger with the attachment according to the second embodiment.

FIG. 30 is a bottom view of the earth auger with the attachment according to the second embodiment.

FIG. 31 is a rear view of the earth auger with the attachment according to the second embodiment.

FIG. 32 is a front view of the earth auger with the attachment according to the second embodiment.

FIG. 33 is a perspective view of an auxiliary pole and a retainer in the second embodiment.

FIG. 34 is a sectional view of the auxiliary pole and the retainer in the second embodiment.

FIG. 35 is a front perspective view of the attachment according to the second embodiment and the earth auger.

FIG. 36 is a right side view of the attachment according to the second embodiment and the earth auger.

FIG. 37 is a front perspective view of an auxiliary pole and a retainer in a modification of the second embodiment.

FIG. 38 is a front perspective view of the earth auger with an attachment according to a third embodiment.

FIG. 39 is a rear perspective view of the earth auger with the attachment according to the third embodiment.

FIG. 40 is a left side view of the earth auger with the attachment according to the third embodiment.

FIG. 41 is a right side view of the earth auger with the attachment according to the third embodiment.

FIG. 42 is a top view of the earth auger with the attachment according to the third embodiment.

FIG. 43 is a bottom view of the earth auger with the attachment according to the third embodiment.

FIG. 44 is a rear view of the earth auger with the attachment according to the third embodiment.

FIG. 45 is a front view of the earth auger with the attachment according to the third embodiment.

FIG. 46 is a side view of the earth auger according to the third embodiment, describing its use.

FIG. 47 is a front view of the earth auger according to the third embodiment, describing its use.

FIG. 48 is a front perspective view of an earth auger according to a fourth embodiment.

FIG. 49 is a front perspective view of an earth auger according to a fifth embodiment.

### DETAILED DESCRIPTION

Although one or more embodiments of the present disclosure are described with reference to the drawings, the present disclosure is not limited to the present embodiments. The components in the embodiments described below may be combined as appropriate. One or more components may be eliminated.

In the embodiments, the positional relationships between the components will be described using the directional terms such as right and left (or lateral), front and rear, and up and down (or vertical). The terms indicate relative positions or directions with respect to the center of an earth auger.

### First Embodiment

### Earth Auger

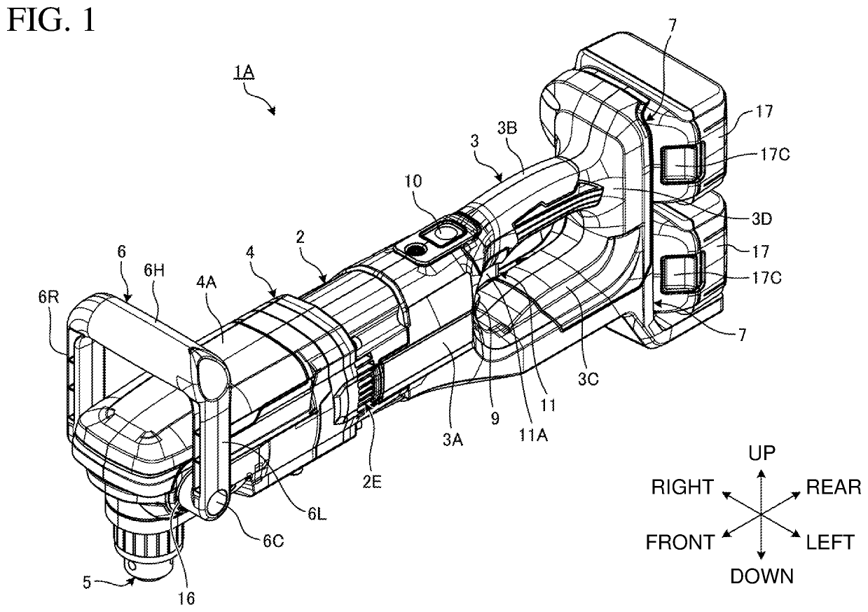

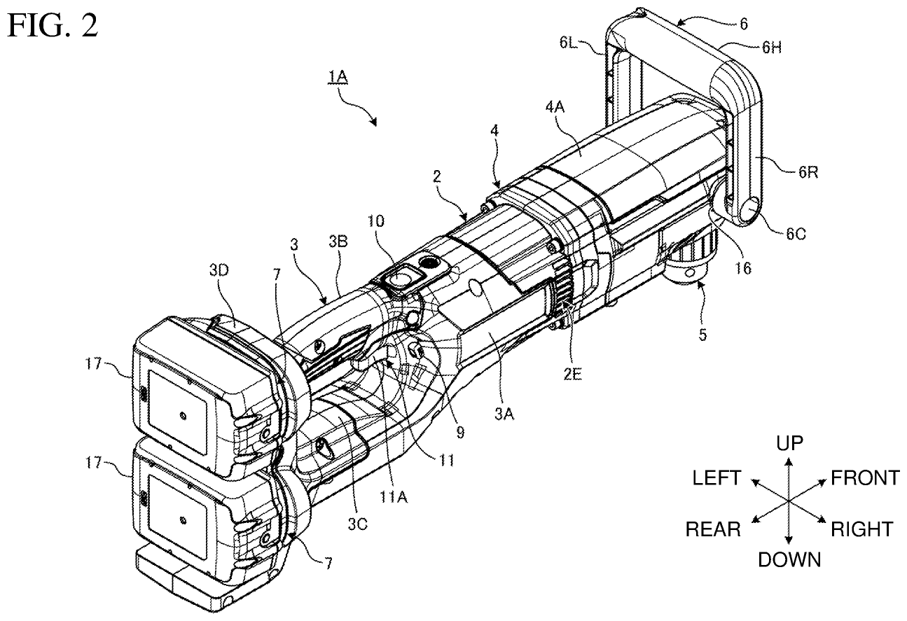

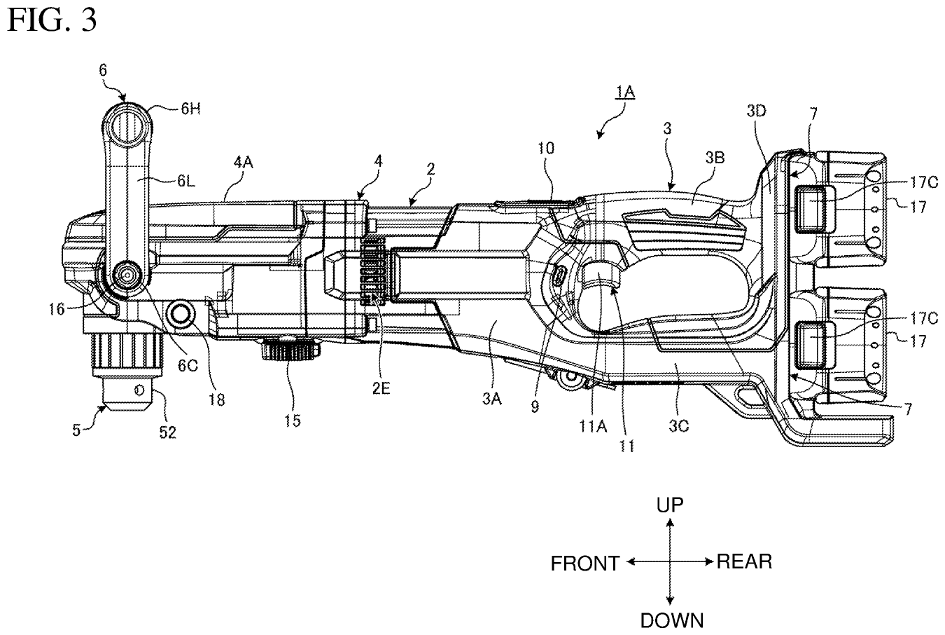

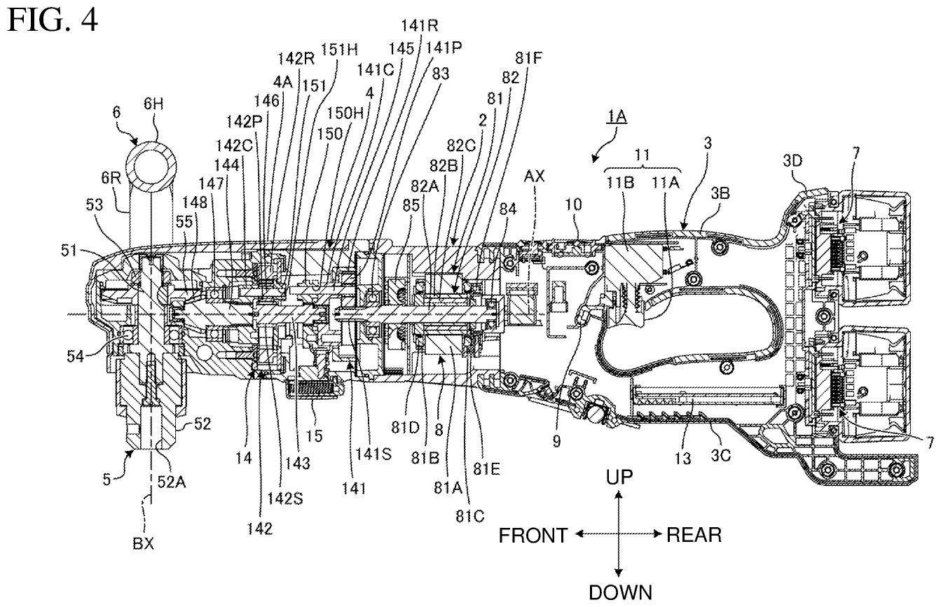

FIG. 1 is a front perspective view of an earth auger 1A according to the present embodiment. FIG. 2 is a rear perspective view of the earth auger 1A according to the present embodiment. FIG. 3 is aside view of the earth auger 1A according to the present embodiment. FIG. 4 is a sectional view of the earth auger 1A according to the present embodiment. The earth auger 1A is a portable earth auger being held by an operator for drilling into a drill target to form a hole in the drill target. The drill target is the ground in the present embodiment.

The earth auger 1A includes a motor housing 2, a handle housing 3, a gear housing 4, a front grip 6, battery mounts 7, a controller 13, a main switch 10, a trigger switch 11, a forward-reverse switch lever 9, a speed switch lever 15, a motor 8, a reducer 14, and a rotation output unit 5.

The motor housing 2 accommodates the motor 8. The motor housing 2 is cylindrical. The motor housing 2 is formed from a synthetic resin. The motor housing 2 has outlets 2E. The outlets 2E connect the inside and the outside of the motor housing 2. The motor housing 2 has the outlets 2E in its left, right, and bottom surfaces. Air in an internal space of the motor housing 2 is discharged out of the motor housing 2 through the outlets 2E.

The handle housing 3 is located behind the motor housing 2. The handle housing 3 has its front connected to the rear of the motor housing 2. The handle housing 3 is an elongated loop in the front-rear direction. The handle housing 3 is formed from a synthetic resin.

The handle housing 3 includes a front portion 3A, a grip portion 3B, a controller compartment 3C, and a battery connector 3D. The front portion 3A is connected to the rear of the motor housing 2. The grip portion 3B extends rearward from an upper portion of the front portion 3A. The controller compartment 3C extends rearward from a lower portion of the front portion 3A. The battery connector 3D connects the rear end of the grip portion 3B and the rear end of the controller compartment 3C. The grip portion 3B is located above the controller compartment 3C. The grip portion 3B is located behind the motor housing 2. The operator holds the grip portion 3B with a hand.

The gear housing 4 accommodates the reducer 14. The gear housing 4 is cylindrical. The gear housing 4 is located in front of the motor housing 2. The gear housing 4 has its rear connected to the front of the motor housing 2. The gear housing 4 is formed from aluminum. The gear housing 4 has its surface at least partially covered with a cover 4A. The cover 4A in the embodiment has a two-layer structure of a synthetic resin and an elastomer.

The front grip 6 is fixed to the gear housing 4. The front grip 6 includes a left arm 6L, a right arm 6R, and a bridge 6H. The left arm 6L is fixed to a left portion of the gear housing 4. The right arm 6R is fixed to a right portion of the gear housing 4. The bridge 6H connects the upper end of the left arm 6L and the upper end of the right arm 6R. The bridge 6H is located above the upper surface of the gear housing 4. The bridge 6H and the gear housing 4 face each other with a space between them. The front grip 6 is located frontward from the motor housing 2. The operator holds the front grip 6.

The left arm 6L and the right arm 6R each have a threaded opening 6C at their lower ends. The gear housing 4 has threaded holes 16 in its right and left portions. The threaded hole 16 are substantially aligned with the rotation output unit 5 in the front-rear direction.

The gear housing 4 has threaded holes 18 in its left and right portions. The threaded holes 18 each are located behind and below the corresponding threaded hole 16.

The battery mounts 7 are located at the rear of the handle housing 3. The battery mounts 7 receive battery packs 17. The battery mounts 7 are located in the battery connector 3D in the handle housing 3. In the present embodiment, two battery mounts 7 are arranged in the vertical direction. Each battery mount 7 receives the corresponding battery pack 17. The two battery packs 17 are thus arranged in the vertical direction. The battery packs 17 are detachable from the battery mounts 7. The battery packs 17 attached to the battery mounts 7 power the earth auger 1A.

Each battery pack 17 includes a secondary battery. The battery pack 17 in the present embodiment includes a rechargeable lithium-ion battery. The battery pack 17 includes a release button 17C. The release button 17C is operable to release the battery pack 17 mounted on the corresponding battery mount 7. The release button 17C is located on the left surface of the battery pack 17.

The controller 13 outputs a control signal for controlling the earth auger 1A. The controller compartment 3C has an internal space that can accommodate the controller 13. The controller 13 is accommodated in the controller compartment 3C.

The main switch 10 is operable to start the earth auger 1A. The main switch 10 is located on the upper surface of the front portion 3A. The main switch 10 causes the battery packs 17 to supply power to the controller 13, starting the earth auger 1A. The main switch 10 is operable to switch the earth auger 1A between the driving state and the stopped state.

The trigger switch 11 is operable to activate the motor 8. The trigger switch 11 is located in the grip portion 3B. The trigger switch 11 includes a trigger lever 11A and a switch circuit 11B. The trigger lever 11A protrudes downward from a lower front portion of the grip portion 3B. The operator holding the grip portion 3B with the right or left hand operates the trigger lever 11A with a finger to move the trigger lever 11A upward. The grip portion 3B has an internal space that can accommodate the switch circuit 11B. The switch circuit 11B is accommodated in the grip portion 3B. In response to an operation on the trigger lever 11A, the switch circuit 11B outputs an operation signal. In response to the trigger lever 11A being pulled upward with the earth auger 1A being started, the battery packs 17 supply power to the motor 8 and activate the motor 8. The motor 8 is driven in response to the operation signal output from the switch circuit 11B. The trigger lever 11A is operable to switch between the operation state and the release state to switch the motor 8 between the driving state and the stopped state.

The forward-reverse switch lever 9 is operable to change the rotation direction of the motor 8. The forward-reverse switch lever 9 is located in the front portion 3A. The forward-reverse switch lever 9 is operable rightward or leftward to switch the rotation direction of the motor 8 between forward and reverse. This can switch the rotation direction of the rotation output unit 5 between forward and reverse.

The speed switch lever 15 is operable to switch the rotational speed of the rotation output unit 5. The speed switch lever 15 is located in a lower portion of the gear housing 4. An operation on the speed switch lever 15 in the front-rear direction switches the rotational speed of the rotation output unit 5 between a first speed and a second speed. The second speed is higher than the first speed.

The motor 8 generates a rotational force for rotating the rotation output unit 5. The motor 8 is driven by power supplied from the battery packs 17. The motor 8 is an inner-rotor brushless motor. The motor 8 includes a cylindrical stator 81 and a rotor 82. The rotor 82 is located inside the stator 81. The rotor 82 has its rotation axis AX extending in the front-rear direction.

The stator 81 includes a stator core 81A, a front insulator 81B, a rear insulator 81C, multiple coils 81D, a sensor circuit board 81E, and a connection wire 81F. The stator core 81A includes multiple steel plates stacked on one another. The front insulator 81B is located at the front of the stator core 81A. The rear insulator 81C is located at the rear of the stator core 81A. The coils 81D are wound around the stator core 81A with the front insulator 81B and the rear insulator 81C between them. The sensor circuit board 81E is attached to the rear insulator 81C. The connection wire 81F is supported by the rear insulator 81C. The sensor circuit board 81E includes multiple rotation detectors to detect rotation of the rotor 82.

The rotor 82 includes a rotor shaft 82A, a rotor core 82B, and multiple permanent magnets 82C. The rotor core 82B is cylindrical and surrounds the rotor shaft 82A. The permanent magnets 82C are held by the rotor core 82B. The rotor shaft 82A has a front portion supported by a bearing 83 in a rotatable manner. The rotor shaft 82A has a rear portion supported by a bearing 84 in a rotatable manner.

A centrifugal fan 85 is mounted on a part of the rotor shaft 82A between the bearing 83 and the stator 81. The outlets 2E in the motor housing 2 are located to partially surround the centrifugal fan 85. As the rotor shaft 82A rotates and the centrifugal fan 85 rotates, air in the internal space of the motor housing 2 is discharged out of the motor housing 2 through the outlets 2E.

The rotor shaft 82A receives a pinion gear 141S on its front end. The pinion gear 141S is located in an internal space of the gear housing 4. The rotor shaft 82A is connected to the reducer 14 with the pinion gear 141S in between.

The reducer 14 transmits a rotational force generated by the motor 8 to the rotation output unit 5. The reducer 14 transmits the rotational force through the rotor shaft 82A to the rotation output unit 5. The reducer 14 includes multiple gears. The reducer 14 includes a first planetary gear assembly 141, a second planetary gear assembly 142, a countershaft 143, and an output shaft 144.

The first planetary gear assembly 141 is located at the front of the rotor shaft 82A. The countershaft 143 is located in front of the first planetary gear assembly 141. The second planetary gear assembly 142 is located in front of the countershaft 143. The output shaft 144 is located in front of the second planetary gear assembly 142.

The first planetary gear assembly 141 includes the pinion gear 141S, multiple planetary gears 141P, a first carrier 141C, an internal gear 141R, and a support pin 145. The pinion gear 141S serves as a sun gear. The planetary gears 141P surround the pinion gear 141S. The first carrier 141C supports the planetary gears 141P in a rotatable manner. The internal gear 141R surrounds the planetary gears 141P. The support pin 145 is held by the first carrier 141C.

The pinion gear 141S is located at the front end of the rotor shaft 82A. The planetary gears 141P mesh with the pinion gear 141S and the internal gear 141R. The first carrier 141C holds the support pin 145. The support pin 145 extends in the front-rear direction. The support pin 145 is connected to the planetary gears 141P. The first carrier 141C supports the planetary gears 141P in a rotatable manner with the support pin 145.

The second planetary gear assembly 142 includes a sun gear 142S, multiple planetary gears 142P, a second carrier 142C, an internal gear 142R, and a support pin 146. The planetary gears 142P surround the sun gear 142S. The second carrier 142C supports the planetary gears 142P in a rotatable manner. The internal gear 142R surrounds the planetary gears 142P. The support pin 146 is held by the second carrier 142C.

The sun gear 142S is located at the front end of the countershaft 143. The planetary gears 142P mesh with the sun gear 142S and the internal gear 142R. The second carrier 142C holds the support pin 146. The support pin 146 extends in the front-rear direction. The support pin 146 protrudes rearward from the second carrier 142C. The support pin 146 supports the planetary gears 142P in a rotatable manner. The support pin 146 has its rear end protruding rearward from the planetary gears 142P. The second carrier 142C supports the planetary gears 142P in a rotatable manner with the support pin 146.

The internal gear 141R in the first planetary gear assembly 141 is fixed to the gear housing 4. The internal gear 141R does not rotate. The internal gear 142R in the second planetary gear assembly 142 is rotatable.

The output shaft 144 is supported by the bearing 147 in a rotatable manner. The output shaft 144 has its rear end fixed to the second carrier 142C. The output shaft 144 receives a bevel gear 148 at its front end. The output shaft 144 has its front end connected to the rotation output unit 5 with the bevel gear 148 in between. As the second carrier 142C rotates, the second carrier 142C and the output shaft 144 rotate together.

The rotation axis AX of the rotor shaft 82A, the rotation axis of the first carrier 141C, the rotation axis of the countershaft 143, the rotation axis of the second carrier 142C, and the rotation axis of the output shaft 144 are aligned with one another.

The reducer 14 includes a switching member 150. The switching member 150 is movable in the front-rear direction between the first planetary gear assembly 141 and the second planetary gear assembly 142. The switching member 150 surrounds the countershaft 143. The switching member 150 is connected to the speed switch lever 15. In response to an operation on the speed switch lever 15, the switching member 150 moves in the front-rear direction. The operator operates the speed switch lever 15 to move the switching member 150 in the front-rear direction.

The switching member 150 is located in front of the first carrier 141C. The support pin 145 includes a front portion protruding frontward from the first carrier 141C. The switching member 150 has a hole 150H. The support pin 145 protruding frontward from the first carrier 141C is placed in the hole 150H. The switching member 150 is movable in the front-rear direction while being guided by the support pin 145. This switches the rotational speed of the rotation output unit 5.

The reducer 14 includes a connector 151 at the rears of the planetary gears 142P. The connector 151 has a hole 151H. The support pin 146 protruding rearward from the planetary gears 142P is placed in the hole 151H. The connector 151 is connected to the second carrier 142C with the support pin 146.

The switching member 150 is movable between a first position and a second position. The second position is frontward from the first position. The switching member 150 is movable between the first position and the second position while being guided by the support pin 145.

At the first position, the switching member 150 is connected to the first carrier 141C and the countershaft 143. The switching member 150 is apart from the connector 151. The first carrier 141C, the rear end of the countershaft 143, and the switching member 150 are integral with one another. As the first carrier 141C rotates, the first carrier 141C, the countershaft 143, and the switching member 150 rotate together.

At the second position, the switching member 150 is connected to the connector 151. The switching member 150 is apart from the first carrier 141C and from the countershaft 143. The rear end of the countershaft 143 is separate from the first carrier 141C. The connector 151 and the switching member 150 are integral with each other. The support pin 145 is placed in the hole 150H in the switching member 150. The support pin 145 is connected to the planetary gears 141P. As the planetary gears 141P revolve, the connector 151 and the switching member 150 rotate together.

At the first position, the switching member 150 is connected to the countershaft 143 with splines. At the second position, the switching member 150 is disconnected from the countershaft 143 in response to disengagement of the splines.

With the switching member 150 at the first position, the pinion gear 141S rotates and the planetary gears 141P revolve about the pinion gear 141S as the motor 8 drives the rotor shaft 82A to rotate. In this state, the first carrier 141C, the rear end of the countershaft 143, and the switching member 150 are integral with one another. As the planetary gears 141P revolve, the first carrier 141C, the countershaft 143, and the switching member 150 rotate together at a lower rotational speed than the rotor shaft 82A. As the countershaft 143 rotates, the sun gear 142S rotates. The planetary gears 142P then revolve about the sun gear 142S. The second carrier 142C and the output shaft 144 then rotate at a lower rotational speed than the countershaft 143. With the switching member 150 at the first position, both the first planetary gear assembly 141 and the second planetary gear assembly 142 operate for rotation reduction as the motor 8 drives, thus causing the output shaft 144 to rotate at the first speed.

With the switching member 150 at the second position, the pinion gear 141S rotates and the planetary gears 141P revolve about the pinion gear 141S as the motor 8 drives the rotor shaft 82A to rotate. The first carrier 141C then rotates at a lower rotational speed than the rotor shaft 82A. At the second position, the switching member 150 is apart from the first carrier 141C and the countershaft 143. The rear end of the countershaft 143 is separate from the first carrier 141C. The connector 151 and the switching member 150 are integral with each other. The support pin 145 is placed in the hole 150H in the switching member 150. The revolving planetary gears 141P cause the connector 151 and the switching member 150 to rotate at the same rotational speed as the first carrier 141C. The rotating connector 151 causes the planetary gears 142P to revolve at a revolution speed that is the same as the rotational speed of the connector 151. The revolving planetary gears 142P cause the second carrier 142C and the output shaft 144 to rotate at the same rotational speed as the countershaft 143. With the switching member 150 at the second position, the first planetary gear assembly 141 operates for rotation reduction as the motor 8 drives, but the second planetary gear assembly 142 does not operate for rotation reduction. The output shaft 144 thus rotates at the second speed.

The rotation output unit 5 rotates by the rotational force transmitted from the motor 8 through the reducer 14. The rotation output unit 5 protrudes downward from a front portion of the gear housing 4. The rotation output unit 5 receives a drill bit. The rotation output unit 5 with the drill bit being attached is rotatable. The rotation output unit 5 has its rotation axis BX extending in the vertical direction. The motor 8 has the rotation axis AX orthogonal to the rotation axis BX of the rotation output unit 5.

The rotation output unit 5 includes a spindle 51 and a drill chuck 52. The drill chuck 52 is attached to the lower end of the spindle 51. The drill chuck 52 has an insertion hole 52A. The drill bit is placed in the insertion hole 52A. The insertion hole 52A extends upward from the lower end of the drill chuck 52. The drill chuck 52 with the drill bit being attached is rotatable.

The spindle 51 is supported by a needle bearing 53 and a ball bearing 54 in a rotatable manner. The needle bearing 53 supports the upper end of the spindle 51 in a rotatable manner. The ball bearing 54 supports a lower portion of the spindle 51 in a rotatable manner.

The spindle 51 receives a bevel gear 55 at its upper end. The bevel gear 55 meshes with the bevel gear 148 on the output shaft 144. The bevel gear 55 has a larger diameter than the bevel gear 148. The bevel gear 55 includes more teeth than the bevel gear 148.

An operation example of an earth auger 1A according to the present embodiment will now be described. In response to an operation on the main switch 10 with the battery packs 17 attached to the battery mount 7, the battery packs 17 power the earth auger 1A. In response to an operation on the trigger switch 11 in this state, the switch circuit 11B outputs an operation signal. The controller 13 supplies a current to the motor 8 in response to the operation signal output from the switch circuit 11B. This rotates the rotor shaft 82A.

As the rotor shaft 82A rotates, the first planetary gear assembly 141, the countershaft 143, and the second planetary gear assembly 142 are driven to turn the output shaft 144. The bevel gear 148 on the output shaft 144 meshes with the bevel gear 55 on the spindle 51. As the output shaft 144 rotates, the spindle 51 rotates. The drill chuck 52 then rotates. This rotates the drill bit attached to the drill chuck 52.

As the rotor shaft 82A rotates, the centrifugal fan 85 rotates. The air flowing around the motor 8 cools the motor 8. The air flowing around the motor 8 is discharged through the outlets 2E.

### Attachment

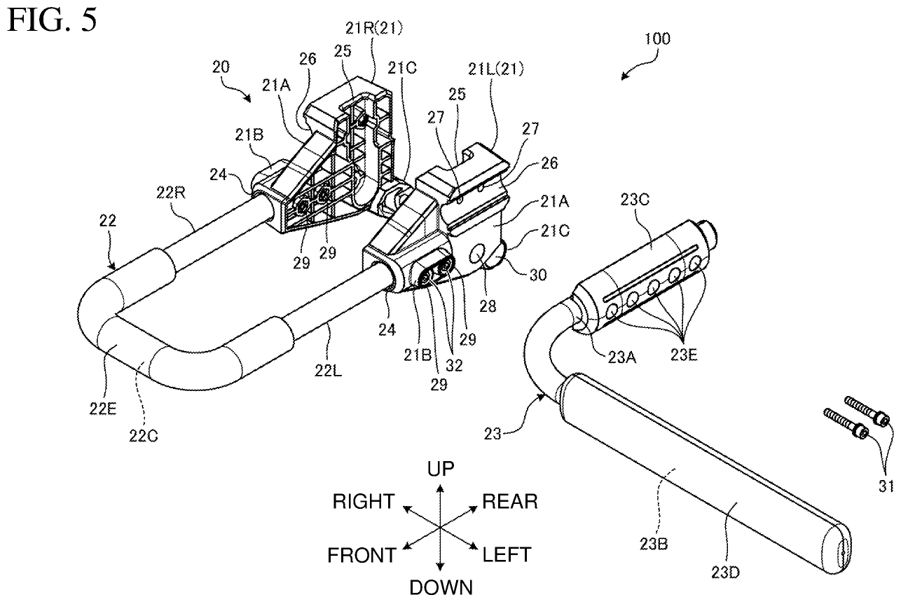

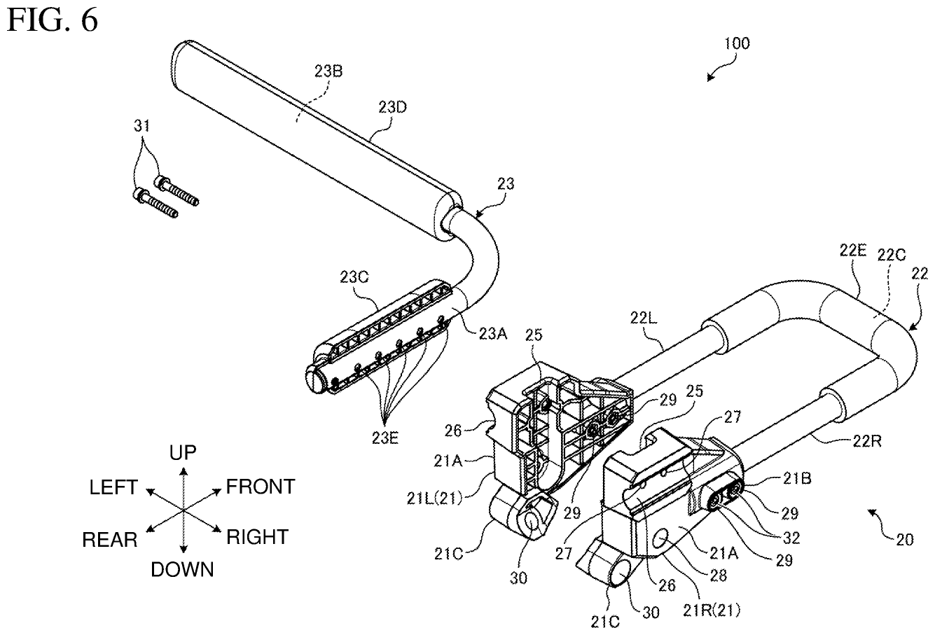

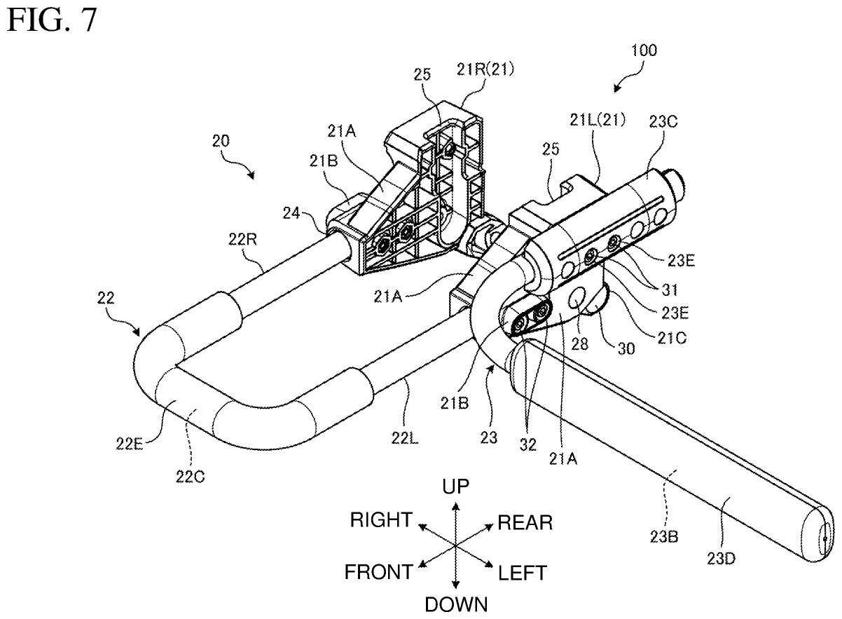

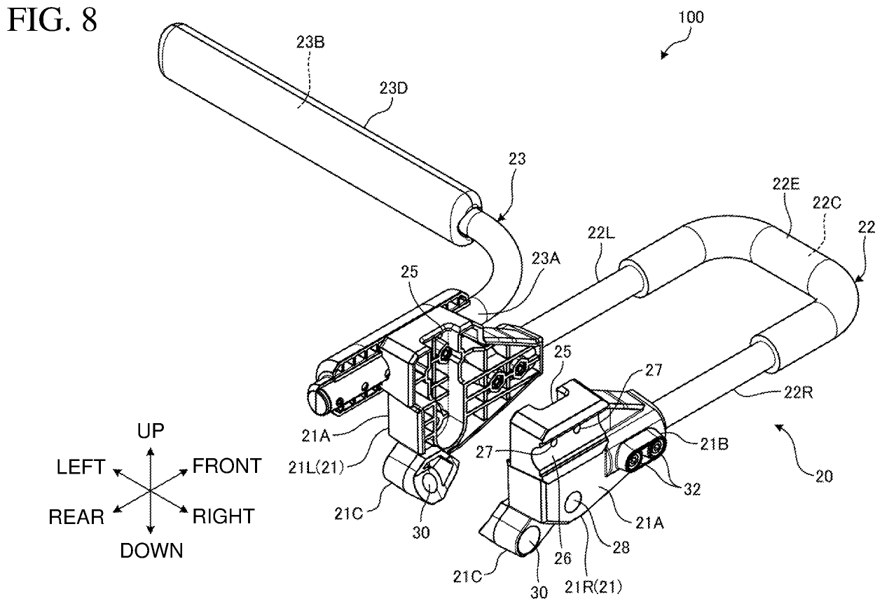

FIG. 5 is an exploded front perspective view of parts of an attachment 100 according to the present embodiment. FIG. 6 is an exploded rear perspective view of the parts of the attachment 100 according to the present embodiment. FIG. 7 is a front perspective view of the parts of the attachment 100 according to the present embodiment. FIG. 8 is a rear perspective view of the parts of the attachment 100 according to the present embodiment.

The attachment 100 is attachable to the earth auger 1A. The attachment 100 according to the present embodiment is attachable to the gear housing 4 in the earth auger 1A. The attachment 100 is attachable to and detachable from the gear housing 4 in the earth auger 1A.

The attachment 100 includes an auxiliary handle 20 attachable to and detachable from the gear housing 4. The auxiliary handle 20 receives a reaction force transmitted from the rotation output unit 5 to the gear housing 4. The auxiliary handle 20 includes handle joints 21, a handle 22, and a reaction force receiver 23.

The handle joints 21 are fastened to the gear housing 4. The handle joints 21 include a left handle joint 21L and a right handle joint 21R. The left handle joint 21L is fastened to the left portion of the gear housing 4. The right handle joint 21R is fastened to the right portion of the gear housing 4.

The handle 22 is fastened to the handle joints 21. The handle 22 extends frontward from the handle joints 21. The handle 22 includes a left rod 22L, a right rod 22R, and a connecting rod 22C. The left rod 22L extends frontward from the left handle joint 21L. The right rod 22R extends frontward from the right handle joint 21R. The connecting rod 22C connects the front end of the left rod 22L and the front end of the right rod 22R.

The handle 22 is a single pipe that is bent. The handle 22 may include multiple pipes welded together. The handle 22 is formed from metal such as aluminum. In the present embodiment, the front end of the left rod 22L, the front end of the right rod 22R, and the connecting rod 22C are covered with a cover 22E. The cover 22E is formed from a synthetic resin or rubber.

The reaction force receiver 23 is fastened to one of the handle joints 21. The reaction force receiver 23 is located outward (leftward) from the handle joint 21 in the lateral direction with respect to the middle of the auxiliary handle 20. The reaction force receiver 23 includes a fixing rod 23A and an extension rod 23B. The fixing rod 23A extends in the front-rear direction. The extension rod 23B protrudes outward (leftward) from the front end of the fixing rod 23A in the lateral direction with respect to the middle of the auxiliary handle 20.

The reaction force receiver 23 is a single pipe that is bent. The reaction force receiver 23 may include multiple pipes welded together. The reaction force receiver 23 is formed from metal such as aluminum. The fixing rod 23A in the present embodiment is at least partially covered with a cover 23C. The cover 23C is formed from a synthetic resin or rubber. The extension rod 23B is at least partially covered with a cover 23D. The cover 23D is formed from a synthetic resin or rubber.

Each handle joint 21 includes a body 21A, a screw boss 21B, and a screw boss 21C. The body 21A has an inner side surface facing toward the middle of the auxiliary handle 20 and an outer side surface facing opposite to the inner side surface in the lateral direction. The inner surface of the body 21A faces the gear housing 4.

The screw boss 21B protrudes outward from the outer side surface of the body 21A in the lateral direction with respect to the middle of the auxiliary handle 20.

The screw boss 21C is connected to a lower rear portion of the body 21A.

The body 21A has a handle hole 24, an inner recess 25, an outer recess 26, threaded holes 27, and a threaded opening 28. The screw boss 21B has threaded openings 29. The screw boss 21C has a threaded opening 30.

The handle hole 24 extends rearward from the front end of the body 21A. The rear end of the left rod 22L is placed in the handle hole 24 in the left handle joint 21L. The rear end of the right rod 22R is placed in the handle hole 24 in the right handle joint 21R.

The inner recess 25 is a cutout in portions of the upper surface and the inner side surface of the body 21A. The inner recess 25 receives at least a part of the front grip 6. The inner recess 25 on the left handle joint 21L receives the left arm 6L. The inner recess 25 on the right handle joint 21R receives the right arm 6R.

The outer recess 26 is located on the outer surface of the body 21A. The outer recess 26 is recessed from the outer surface of the body 21A toward the middle of the auxiliary handle 20 in the lateral direction. The outer recess 26 extends in the front-rear direction. The outer recess 26 receives at least a part of the fixing rod 23A.

With an imaginary axis extending in the front-rear direction as a front-rear axis, the inner surface of the outer recess 26 recesses in an arc toward the middle of the auxiliary handle 20 in the lateral direction in a plane orthogonal to the front-rear axis. In a plane orthogonal to the front-rear axis, the outer surface of the fixing rod 23A facing the inner surface of the outer recess 26 curves in an arc toward the middle of the auxiliary handle 20 in the lateral direction. The inner surface of the outer recess 26 is in contact with the outer surface of the fixing rod 23A.

Threaded holes 27 are in the outer recess 26. Two threaded holes 27 are located at an interval in the front-rear direction in the outer recess 26. Threaded openings 23E are located in the fixing rod 23A and the cover 23C. Five threaded openings 23E are located at intervals in the front-rear direction. With the fixing rod 23A received in the outer recess 26, screws 31 are placed in the corresponding threaded holes 27 through the threaded openings 23E. The reaction force receiver 23 is thus fastened to the handle joint 21 with the screws 31.

Two screws 31 are arranged in the front-rear direction. The threaded openings 23E to receive the screws 31 are selected to adjust the position of the reaction force receiver 23 in the front-rear direction.

The reaction force receiver 23 is fastened to either the left handle joint 21L or the right handle joint 21R. To fasten the reaction force receiver 23 to the left handle joint 21L, the fixing rod 23A placed in the outer recess 26 on the left handle joint 21L is fastened to the left handle joint 21L with the screws 31. To fasten the reaction force receiver 23 to the right handle joint 21R, the fixing rod 23A placed in the outer recess 26 on the right handle joint 21R is fastened to the right handle joint 21R with the screws 31.

FIGS. 5 and 6 are views of the handle joint 21 and the reaction force receiver 23 separate from each other. FIGS. 7 and 8 are views of the left handle joint 21L and the reaction force receiver 23 fastened together with the screws 31.

Two threaded openings 29 are located at an interval in the front-rear direction in the screw boss 21B. The threaded openings 29 connect to the inner surface of handle holes 24. Screws 32 are placed in the threaded openings 29 to fasten the handle 22 to the handle joint 21. Two screws 32 are arranged in the front-rear direction. The screws 32 in the threaded openings 29 are placed in threaded holes in the handle 22. The handle 22 is fastened to the handle joint 21 with the screws 32. The screws 32 in the corresponding threaded openings 29 in the left handle joint 21L are placed in the threaded holes in the left rod 22L. This fastens the left rod 22L to the left handle joint 21L. The screws 32 in the corresponding threaded openings 29 in the right handle joint 21R are placed in the threaded holes in the right rod 22R. This fastens the right rod 22R to the right handle joint 21R.

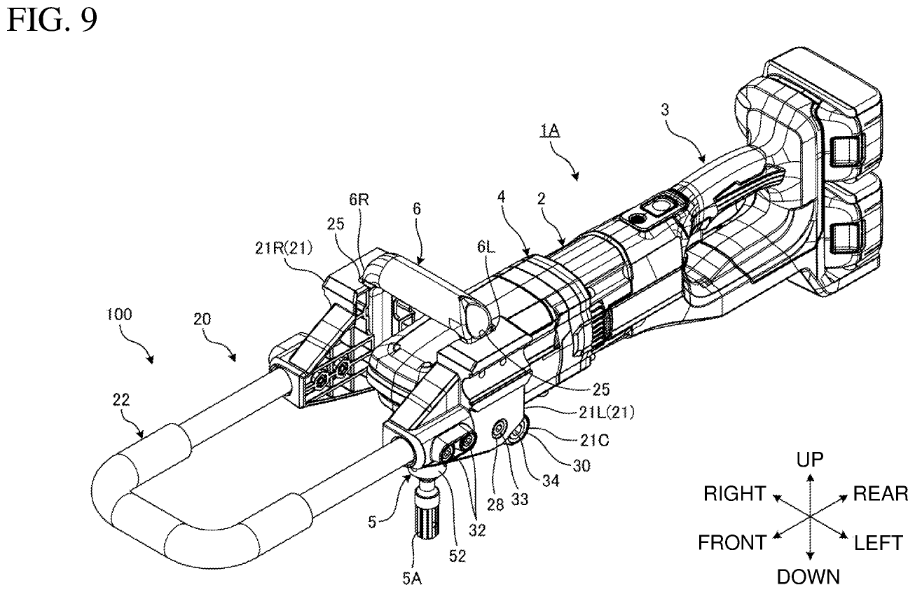

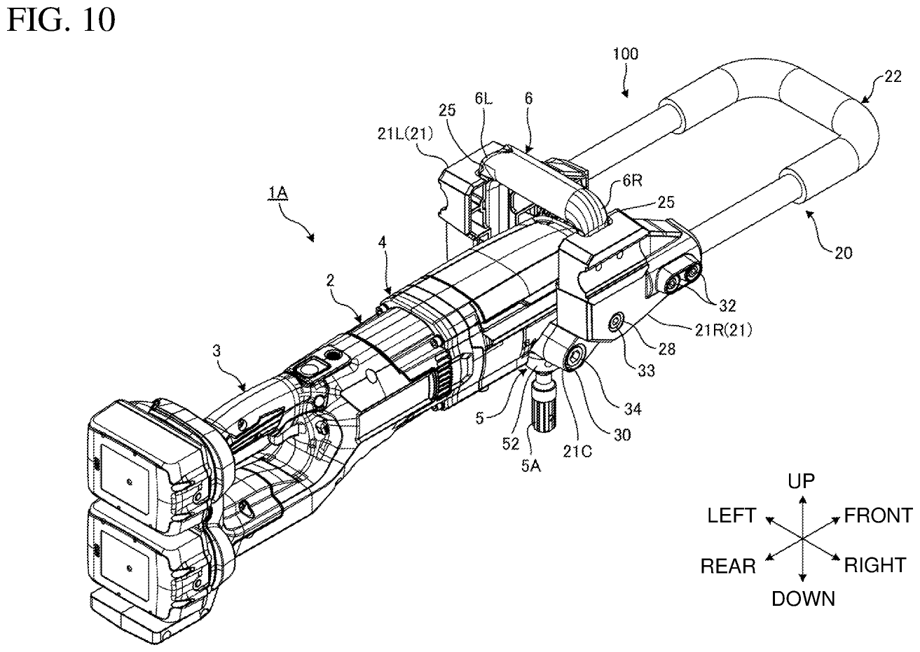

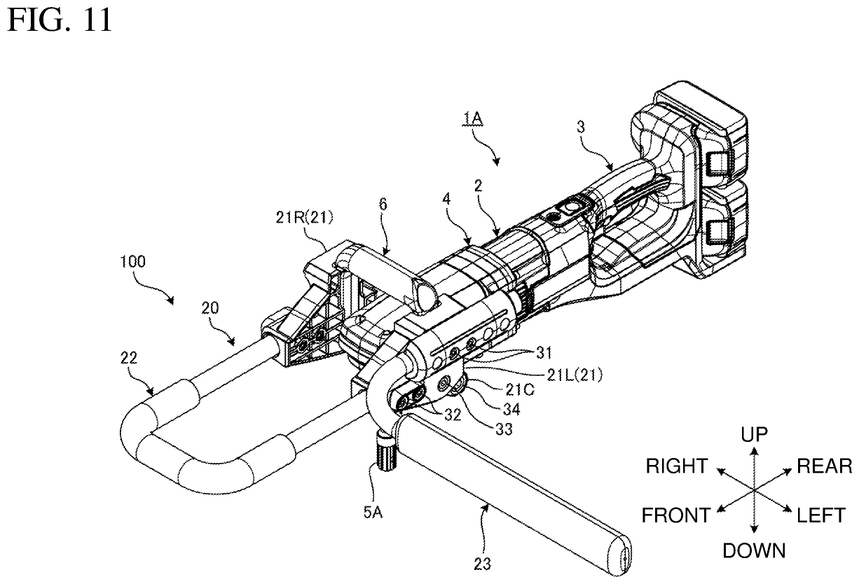

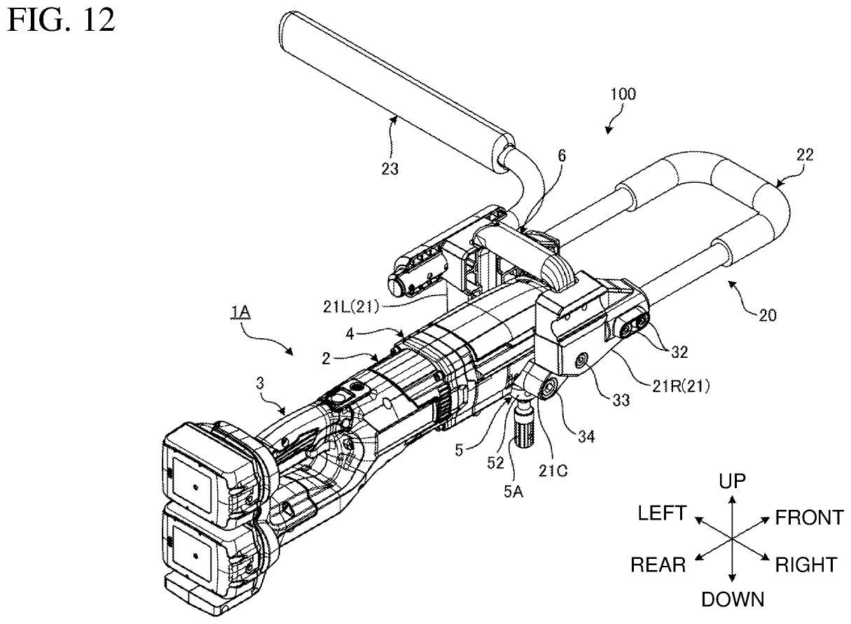

FIG. 9 is a front perspective view of the earth auger 1A with a part of the attachment 100 according to the present embodiment being attached. FIG. 10 is a rear perspective view of the earth auger 1A with the part of the attachment 100 according to the present embodiment being attached. FIG. 11 is a front perspective view of the earth auger 1A with parts of the attachment 100 according to the present embodiment being attached. FIG. 12 is a rear perspective view of the earth auger 1A with the parts of the attachment 100 according to the present embodiment being attached. FIGS. 9 and 10 are views of the auxiliary handle 20 attached to the earth auger 1A with the handle 22 fastened to the handle joints 21 but without the reaction force receiver 23. FIGS. 11 and 12 are views of the auxiliary handle 20 attached to the earth auger 1A with the handle 22 and the reaction force receiver 23 fastened to the handle joints 21.

Each body 21A has the threaded opening 28 frontward from the screw boss 21B. Screws 33 are placed in the corresponding threaded openings 28 with the front grip 6 in between to fasten the handle joints 21 to the gear housing 4. The screws 33 in the threaded openings 28 are placed in the threaded holes 16 in the gear housing 4 through the threaded openings 6C in the front grip 6 (described with reference to FIGS. 1 to 3). The handle joints 21 are fastened to the gear housing 4 with the screws 33 with the front grip 6 in between. The screw 33 in the threaded opening 28 in the left handle joint 21L is placed in the threaded hole 16 in the left portion of the gear housing 4 through the threaded opening 6C in the left arm 6L. This fastens the left handle joint 21L to the left portion of the gear housing 4. The screw 33 in the threaded opening 28 in the right handle joint 21R is placed in the threaded hole 16 in the right portion of the gear housing 4 through the threaded opening 6C in the right arm 6R. This fastens the right handle joint 21R to the right portion of the gear housing 4.

The threaded openings 30 are in the corresponding screw bosses 21C. Screws 34 are placed in the corresponding threaded openings 30 to fasten the handle joints 21 to the gear housing 4. The screws 34 in the threaded openings 30 are placed in the threaded holes 18 in the gear housing 4 (described with reference to, for example, FIG. 3). The handle joints 21 are fastened to the gear housing 4 with the screws 34. The screw 34 in the threaded opening 30 in the left handle joint 21L is placed in the threaded hole 18 in the left portion of the gear housing 4. This fastens the left handle joint 21L to the left portion of the gear housing 4. The screw 34 in the threaded opening 30 in the right handle joint 21R is placed in the threaded hole 18 in the right portion of the gear housing 4. This fastens the right handle joint 21R to the right portion of the gear housing 4.

### Auxiliary Pole

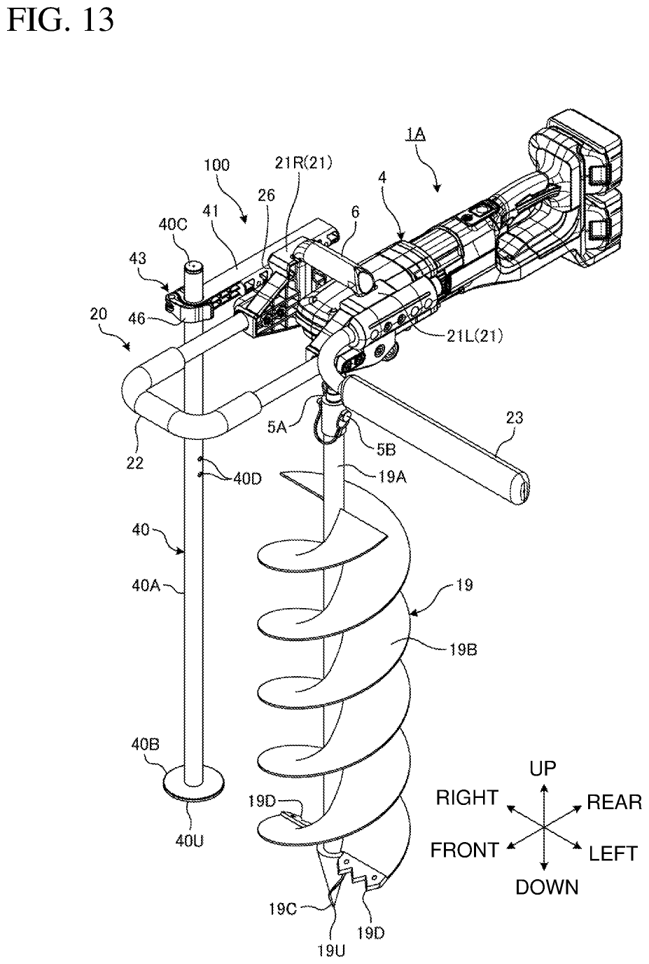

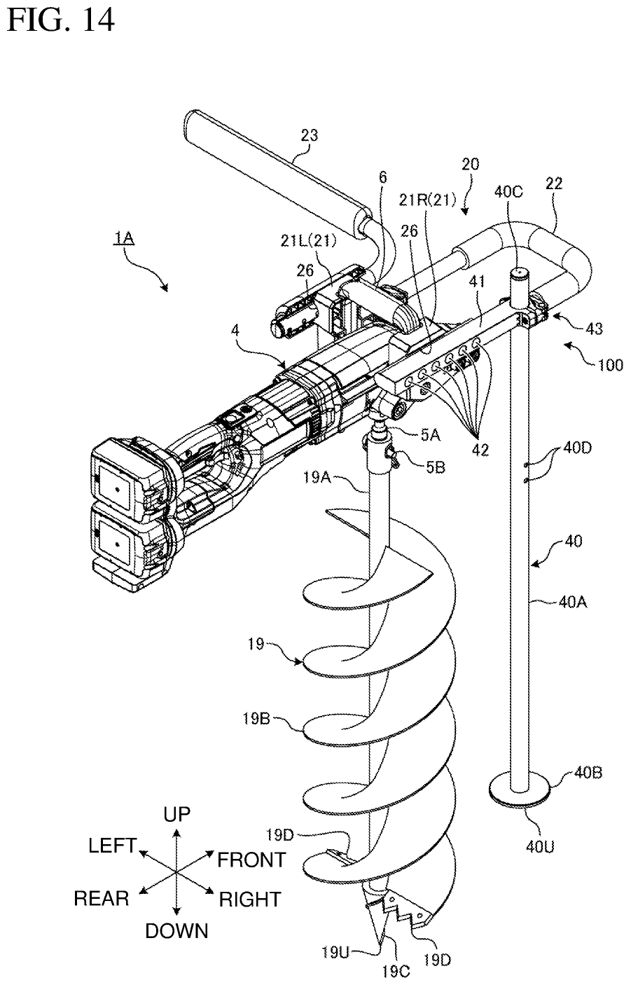

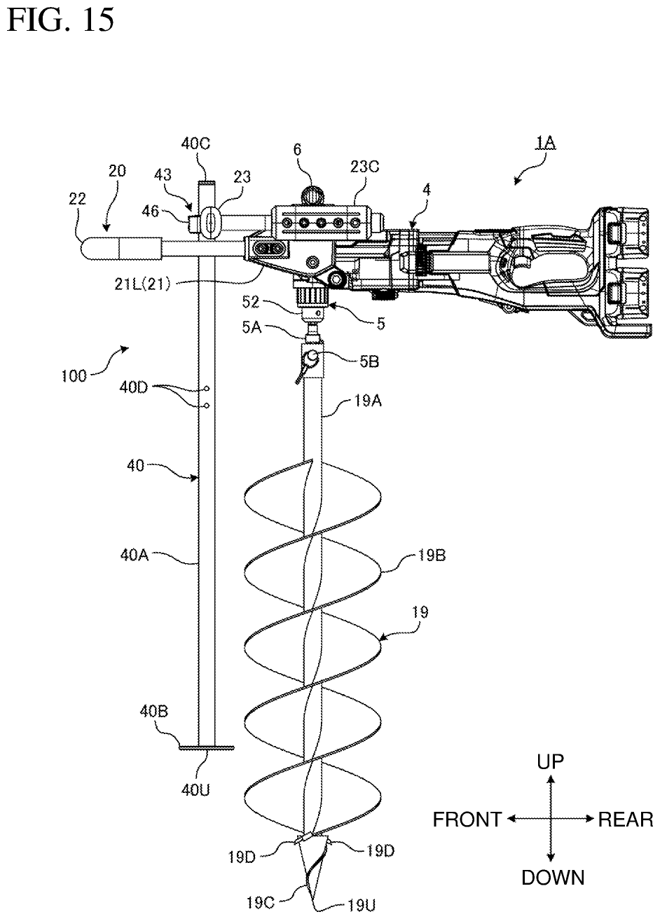

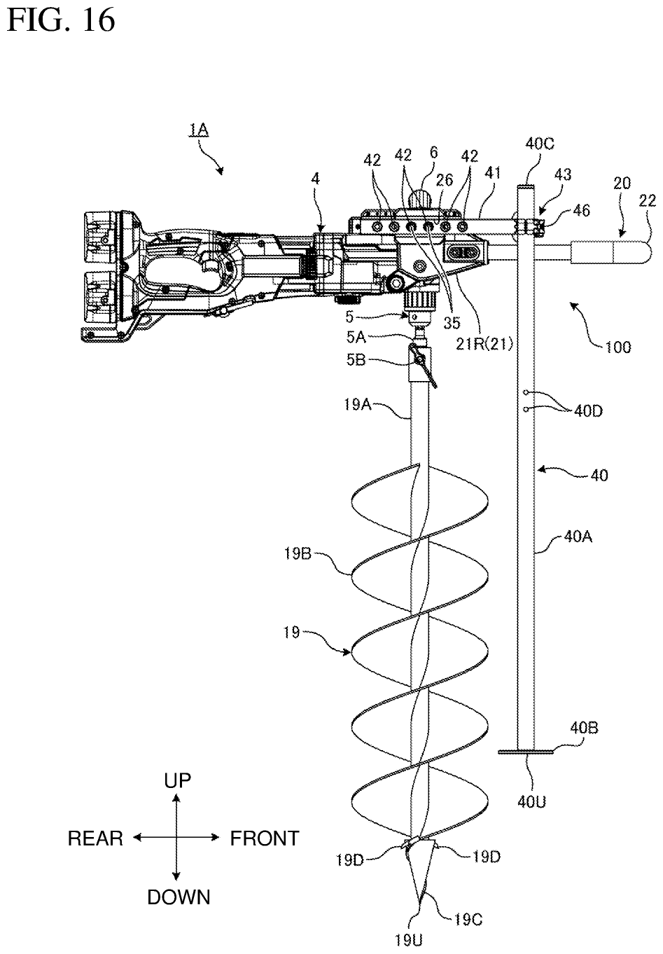

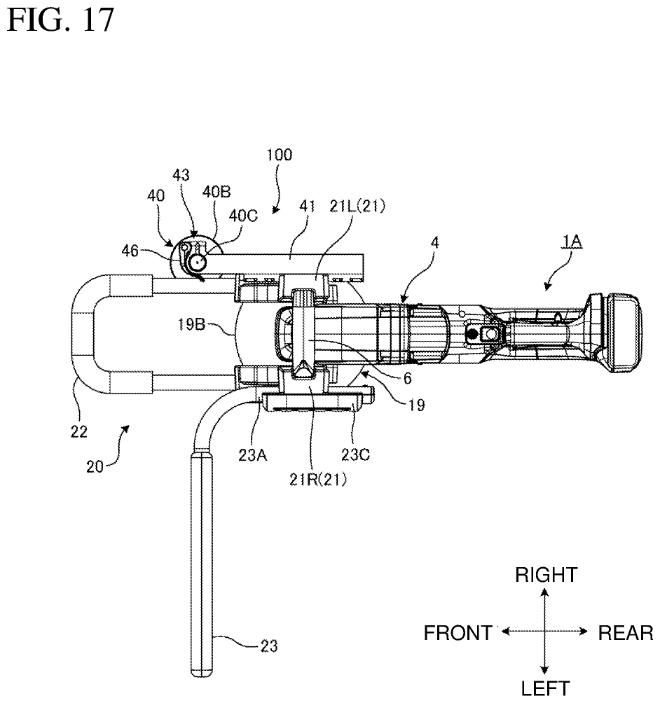

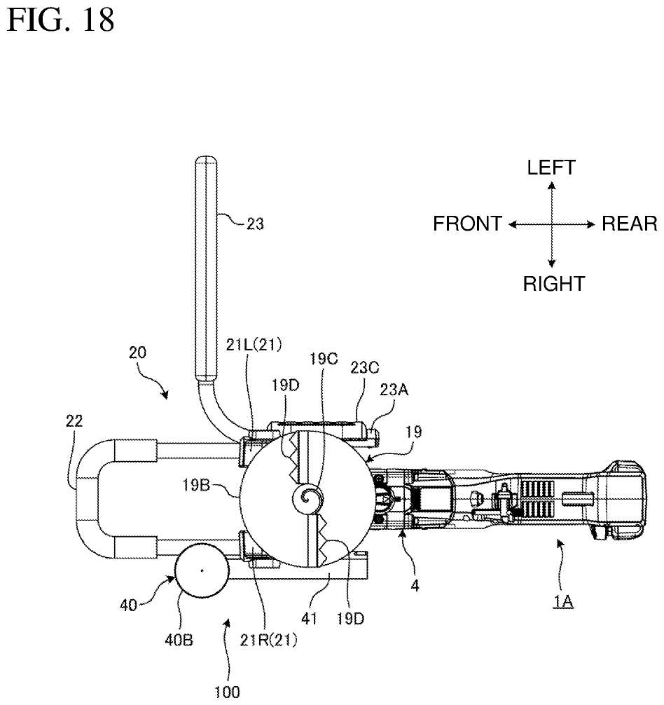

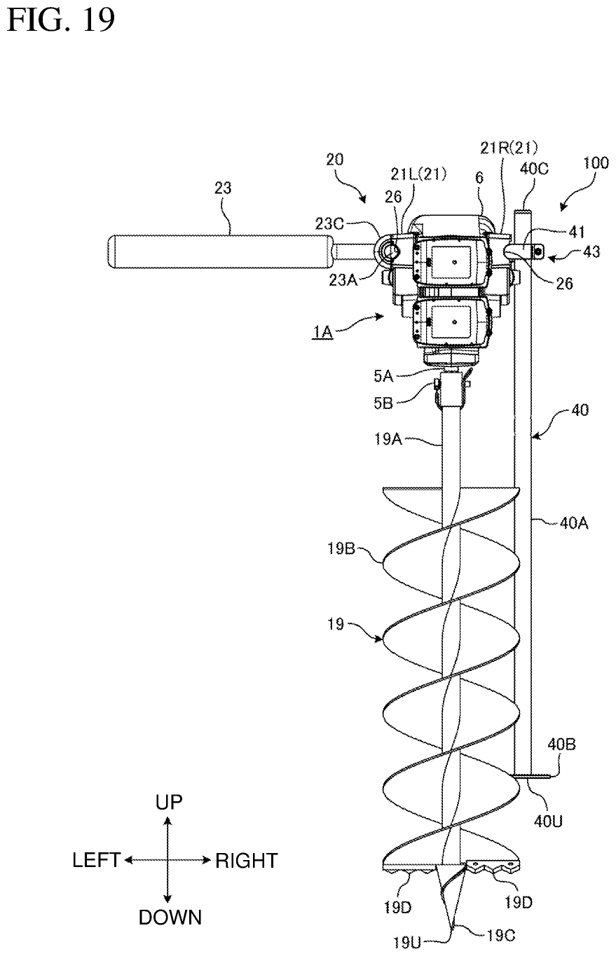

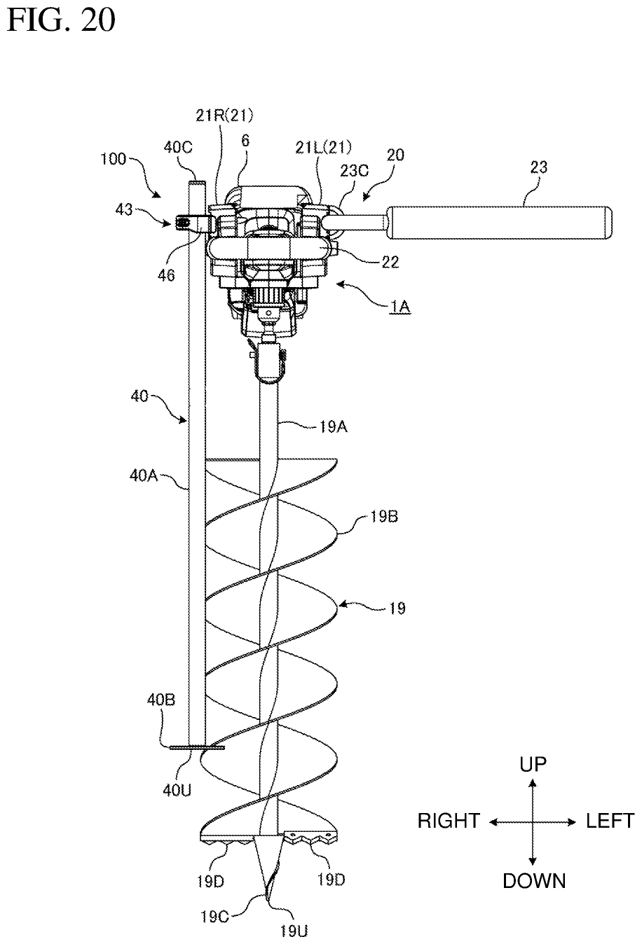

FIG. 13 is a front perspective view of the earth auger 1A with the attachment 100 according to the present embodiment. FIG. 14 is a rear perspective view of the earth auger 1A with the attachment 100 according to the present embodiment. FIG. 15 is a left side view of the earth auger A with the attachment 100 according to the present embodiment. FIG. 16 is a right side view of the earth auger 1A with the attachment 100 according to the present embodiment. FIG. 17 is atop view of the earth auger 1A with the attachment 100 according to the present embodiment. FIG. 18 is a bottom view of the earth auger 1A with the attachment 100 according to the present embodiment. FIG. 19 is a rear view of the earth auger 1A with the attachment 100 according to the present embodiment. FIG. 20 is a front view of the earth auger 1A with the attachment 100 according to the present embodiment.

As shown in FIGS. 13 to 20, the rotation output unit 5 receives a drill bit 19. The drill bit 19 is an earth auger drill bit used for drilling into the ground. The drill bit 19 includes a drill shaft 19A, a drill blade 19B, a tip bit 19C, and a cutting bit 19D.

The drill shaft 19A extends in the vertical direction. To attach the drill bit 19 to the rotation output unit 5, an adapter 5A is placed in the insertion hole 52A in the drill chuck 52 as shown in FIGS. 9 to 12. The adapter 5A is a rod-like member. The drill shaft 19A has a hole to receive the adapter 5A at its upper end. With the adapter 5A placed in the hole at the upper end of the drill shaft 19A, the upper end of the drill shaft 19A and the adapter 5A are fastened with a fastener 5B. The upper end of the drill shaft 19A is attached to the drill chuck 52 using the adapter 5A.

The drill blade 19B spirally surrounds the drill shaft 19A. The drill blade 19B is fixed to the drill shaft 19A.

The tip bit 19C is at the lower end of the drill shaft 19A.

The cutting bit 19D is at the lower end of the drill blade 19B.

As shown in FIGS. 11 and 12, the attachment 100 includes the auxiliary handle 20 attachable to and detachable from the gear housing 4. The auxiliary handle 20 includes the left handle joint 21L, the right handle joint 21R, the handle 22, and the reaction force receiver 23.

As shown in FIGS. 13 to 20, the attachment 100 further includes an auxiliary pole 40. The auxiliary pole 40 extends adjacent to the drill bit 19 in the vertical direction.

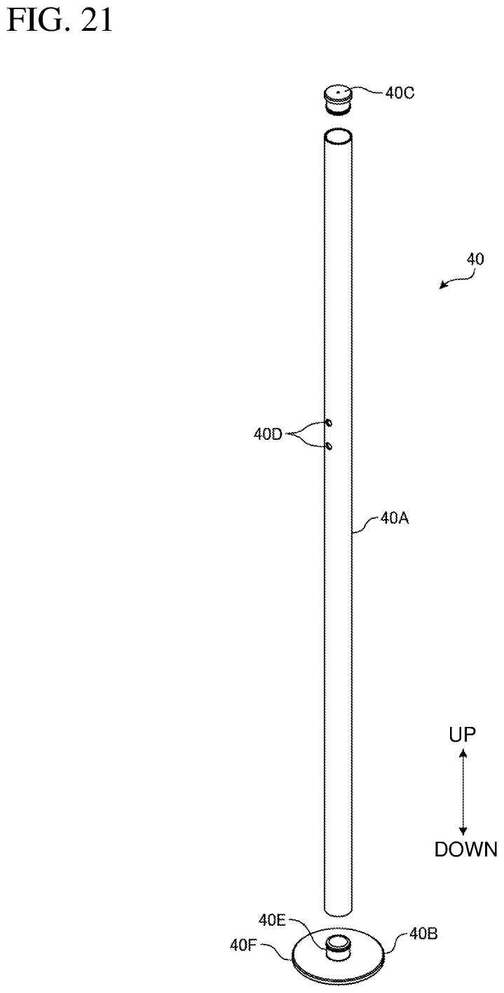

FIG. 21 is an exploded perspective view of the auxiliary pole 40 in the present embodiment. As shown in FIGS. 13 to 21, the auxiliary pole 40 includes a pipe 40A, a leg 40B, and a cap 40C.

The pipe 40A is a straight metal pipe. The pipe 40A extends in the vertical direction. The pipe 40A is located parallel to the drill shaft 19A. The pipe 40A has threaded openings 40D. Two threaded openings 40D are located at an interval in the vertical direction.

The leg 40B is attached to the lower end of the pipe 40A. The leg 40B covers an opening at the lower end of the pipe 40A. The leg 40B is formed from rubber. As shown in FIG. 21, the leg 40B includes a plug 40E and a flange 40F. The plug 40E is placed in the opening at the lower end of the pipe 40A. The flange 40F is connected to the lower end of the plug 40E. The flange 40F has a larger outer diameter than the pipe 40A.

The cap 40C is attached to the upper end of the pipe 40A. The cap 40C covers the upper end of the pipe 40A. At least a part of the cap 40C is placed in the opening at the upper end of the pipe 40A. The cap 40C is formed from rubber.

The auxiliary pole 40 has a lower end 40U located above a lower end 19U of the drill bit 19. As the drill bit 19 rotates, a hole is formed in the ground. The lower end 40U of the auxiliary pole 40 comes in contact with the ground surrounding the hole formed with the drill bit 19 in the ground. This assists the earth auger 1A in drilling the hole to a target depth.

The attachment 100 further includes a retainer 41. The retainer 41 is attachable to and detachable from at least apart of the auxiliary handle 20. The auxiliary pole 40 is held by the retainer 41. The retainer 41 is fastened to one of the handle joints 21. The auxiliary pole 40 is supported by the handle joint 21 with the retainer 41.

The retainer 41 is fastened to either the left handle joint 21L or right handle joint 21R. In the example shown in FIGS. 13 to 20, the reaction force receiver 23 is fastened to the left handle joint 21L. The retainer 41 is fastened to the right handle joint 21R. The auxiliary pole 40 is supported by the right handle joint 21R with the retainer 41.

The retainer 41 extends in the front-rear direction. The outer recess 26 on the right handle joint 21R receives a part of the retainer 41.

As described above, the inner surface of the outer recess 26 recesses is an arc toward the middle of the auxiliary handle 20 in the lateral direction in a plane orthogonal to the front-rear axis. The outer surface of the retainer 41 facing the inner surface the outer recess 26 curves in an arc toward the middle of the auxiliary handle 20 in the lateral direction in a plane orthogonal to the front-rear axis. The inner surface of the outer recess 26 is in contact with the outer surface of the retainer 41.

As described above, the right handle joint 21R has the threaded holes 27 in the outer recess 26. The two threaded holes 27 are located at an interval in the front-rear direction in the outer recess 26. The retainer 41 has multiple (six in the present embodiment) threaded openings 42 located at intervals in the front-rear direction. With the retainer 41 received in the outer recess 26, screws 35 are placed in the corresponding threaded holes 27 through the threaded openings 42. The retainer 41 is thus fastened to the right handle joint 21R with the screws 35.

Two screws 35 are arranged in the front-rear direction. The threaded openings 42 to receive the screws 35 are selected to adjust the positions of the retainer 41 and the auxiliary pole 40 held by the retainer 41 in the front-rear direction.

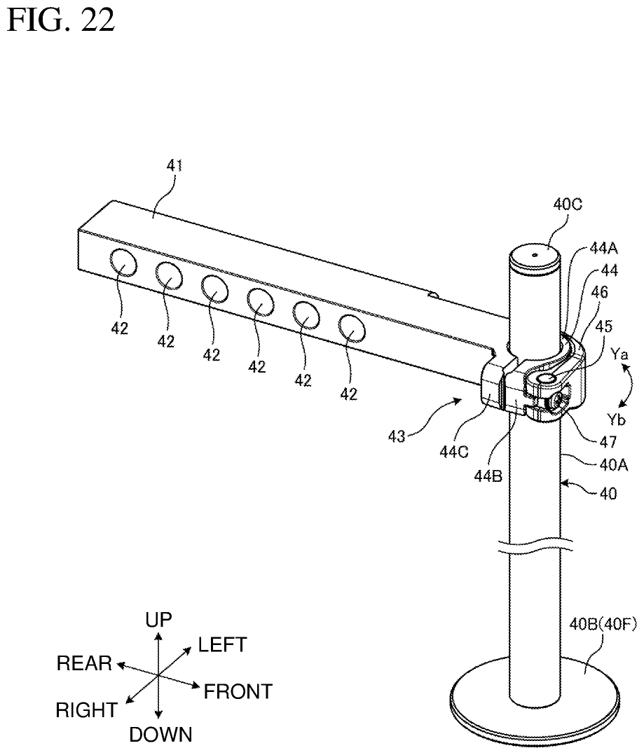

FIG. 22 is a perspective view of the auxiliary pole 40 and the retainer 41 in the present embodiment. The retainer 41 includes a retention assembly 43 that holds the auxiliary pole 40 in a detachable manner.

The retention assembly 43 includes a clamp 44 and a lever 46. The clamp 44 at least partially surrounds the auxiliary pole 40. The lever 46 is connected to the clamp 44 with a hinge 45.

The clamp 44 can lock the auxiliary pole 40. The clamp 44 is at the front end of the retainer 41. The clamp 44 includes an arc 44A, a plate 44B, and a plate 44C. The clamp 44 in the present embodiment is a part of the retainer 41. The arc 44A partially surrounds the pipe 40A. The plate 44B is at one end of the arc 44A. The plate 44C is at the other end of the arc 44A. The plate 44B and the plate 44C face each other across a gap. The plate 44B and the plate 44C are connected together with a screw 47.

The lever 46 is connected to the clamp 44 with the hinge 45. The lever 46 is connected to the clamp 44 with the hinge 45 in a pivotable manner. The operator operates the lever 46 to lock the auxiliary pole 40 with the clamp 44. The lever 46 includes a cam in contact with the plate 44B in the clamp 44.

In response to the lever 46 being rotated in a fastening direction Ya indicated by the arrow in FIG. 22, the pipe 40A is tightened to the clamp 44, and the auxiliary pole 40 is locked to the clamp 44. In other words, the auxiliary pole 40 is secured to the front end of the retainer 41. In response to the lever 46 being rotated in a release direction Yb indicated by the arrow in FIG. 22, the auxiliary pole 40 is unlocked from the clamp 44. This allows the operator to move the auxiliary pole 40 vertically relative to the clamp 44. The operator can adjust the vertical position of the auxiliary pole 40 relative to the retainer 41.

### Method of Use

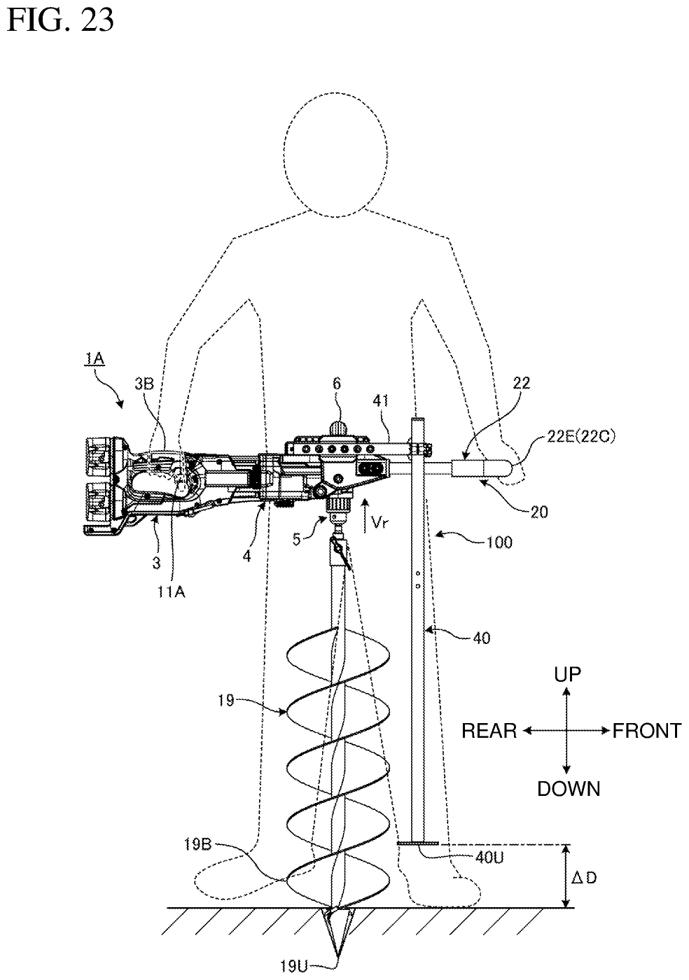

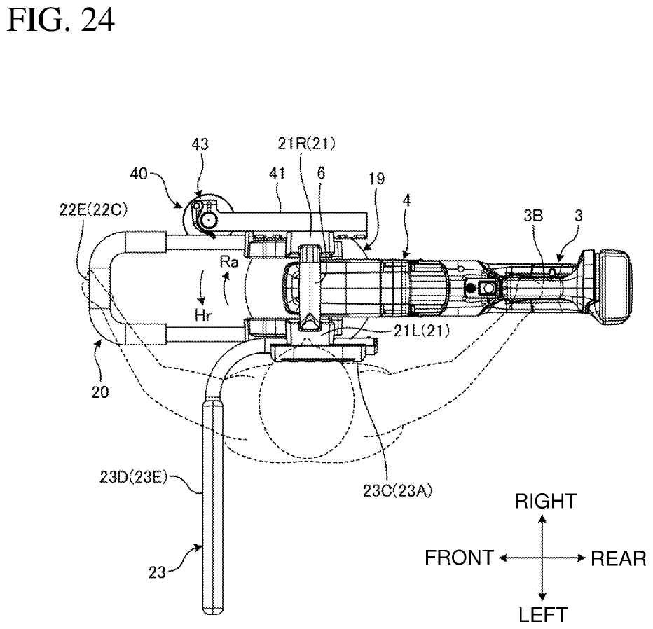

A method of use of the earth auger 1A according to the present embodiment will now be described. FIG. 23 is a side view of the earth auger 1A with the attachment 100 according to the present embodiment, describing its use. FIG. 24 is a plan view of the earth auger 1A with the attachment 100 according to the present embodiment, describing its use. As shown in FIGS. 23 and 24, before drilling into the ground with the earth auger 1A, the drill bit 19 is attached to the rotation output unit 5 and the attachment 100 is attached to the gear housing 4.

The operator holds the connecting rod 22C in the handle 22 with the left hand and the grip portion 3B in the handle housing 3 with the right hand. The operator places the extension rod 23B in the reaction force receiver 23 into contact with the left part of the operator's body. The operator places the extension rod 23B into contact with at least one of the left flank, the left hip, or the thigh of the left leg.

The operator operates the trigger lever 11A with a finger of the right hand holding the grip portion 3B. This causes the rotation output unit 5 to rotate in a predetermined direction Ra indicated by the arrow in FIG. 24, with the drill bit 19 being attached.

The operator pushes the auxiliary handle 20 and the earth auger 1A downward and presses the rotating drill bit 19 against the ground. This causes the earth auger 1A to drill into the ground to form a hole in the ground. The operator can push the handle 22 downward with the left hand and push the grip portion 3B downward with the right hand. The operator can push the front grip 6 downward with the flank. This pushes the gear housing 4 downward.

During drilling into the ground, a large reaction force Vr may act on the gear housing 4 through the drill bit 19 and the rotation output unit 5 in the upward direction indicated by the arrow in FIG. 23. A large reaction force Hr may also act on the gear housing 4 through the drill bit 19 and the rotation output unit 5 in a direction opposite to the predetermined direction Ra indicated by the arrow in FIG. 24.

When the drill bit 19 strikes a hard foreign object such as a rock during drilling into the ground, an excess reaction force may suddenly act on the gear housing 4. When the gear housing 4 receives a large reaction force, the posture of the earth auger 1A may be unstable or the operator holding the earth auger 1A may shake. This may cause difficulty in drilling an intended hole in the ground.

In the present embodiment, the auxiliary handle 20 is attached to the earth auger 1A to receive a reaction force transmitted from the rotation output unit 5 to the gear housing 4. The auxiliary handle 20 includes the handle 22 and the reaction force receiver 23 to receive a reaction force transmitted from the rotation output unit 5 to the gear housing 4.

The connecting rod 22C gripped by the left hand of the operator can receive the reaction force Vr acting in the vertical direction parallel to the rotation axis BX of the rotation output unit 5 and the reaction force Hr acting in the rotation direction of the rotation output unit 5.

The grip portion 3B gripped by the right hand of the operator can receive the reaction force Vr acting in the vertical direction parallel to the rotation axis BX of the rotation output unit 5 and the reaction force Hr acting in the rotation direction of the rotation output unit 5.

The extension rod 23B in contact with the operator's body can receive the reaction force Hr in the rotation direction of the rotation output unit 5.

The connecting rod 22C is located in front of the gear housing 4. The grip portion 3B is located behind the gear housing 4. The extension rod 23B is located at the side of the gear housing 4. The connecting rod 22C gripped by the operator's left hand is distant from the rotation output unit 5. The grip portion 3B gripped by the operator's right hand is distant from the rotation output unit 5. The extension rod 23B in contact with the operator's body is distant from the rotation output unit 5.

As shown in FIG. 23, the upward reaction force Vr transmitted to the gear housing 4 is distributed to the connecting rod 22C, the grip portion 3B, and the front grip 6. The operator thus receives the reaction force Vr in a distributed manner. When the gear housing 4 receives the large reaction force Vr, the posture of the earth auger 1A is less likely to be unstable or the operator holding the earth auger 1A is less likely to shake.

As shown in FIG. 24, the reaction force Hr in the rotation direction transmitted to the gear housing 4 is distributed to the connecting rod 22C, the grip portion 3B, and the extension rod 23B. The operator thus receives the reaction force Hr in a distributed manner. When the gear housing 4 receives the large reaction force Hr, the posture of the earth auger 1A is less likely to be unstable or the operator holding the earth auger 1A is less likely to shake.

The attachment 100 in the present embodiment includes the auxiliary pole 40 extending adjacent to the drill bit 19 in the vertical direction. The auxiliary pole 40 has the lower end 40U located above the lower end 19U of the drill bit 19. A distance ΔD between the lower end of the drill blade 19B and the lower end 19U of the drill bit 19 in the vertical direction is defined as a target depth of the hole to be formed in the ground. The operator performs drilling using the earth auger 1A until the lower end 40U of the auxiliary pole 40 comes in contact with the ground surrounding the hole formed with the drill bit 19 in the ground. The drilling operation is performed using the earth auger 1A until the lower end 40U of the auxiliary pole 40 comes in contact with the ground surrounding the hole formed with the drill bit 19 in the ground. This allows the earth auger 1A to form a hole with a target depth.

At the end of the drilling operation, the operator can pull the earth auger 1A upward by holding at least one of the handle 22, the reaction force receiver 23, the grip portion 3B, or the front grip 6 with the hand. This removes the drill bit 19 from the hole in the ground.

As described above, the attachment 100 according to the present embodiment is attachable to the earth auger 1A. The earth auger 1A includes the motor housing 2 accommodating the motor 8, the handle housing 3 behind the motor housing 2 and including the grip portion 3B receiving the trigger switch 11 operable to activate the motor 8, the gear housing 4 in front of the motor housing 2 and accommodating the gear, and the rotation output unit 5 protruding downward from the gear housing 4 to receive the drill bit 19. The attachment 100 includes the auxiliary pole 40 to be located adjacent to the drill bit 19 and extendable in the vertical direction.

In the above structure, the auxiliary pole 40 assists the drilling operation in forming an intended hole in the ground, which is a drill target. As the drill bit 19 rotates, a hole is formed in the ground. The auxiliary pole 40 comes in contact with the ground surrounding the hole formed with the drill bit 19 in the ground. This allows an intended hole to be formed in the ground.

In the present embodiment, the auxiliary pole 40 has the lower end 40U to be located above the lower end 19U of the drill bit 19.

This allows a hole to be formed with a target depth in the ground. The distance ΔD between the lower end of the drill blade 19B and the lower end 19U of the drill bit 19 in the vertical direction is defined as the target depth of the hole. The drilling operation is performed until the lower end 40U of the auxiliary pole 40 comes in contact with the ground surrounding the hole formed with the drill bit 19. This allows a hole to be formed with a target depth in the ground.

The attachment 100 in the embodiment includes the auxiliary handle 20 attachable to and detachable from the gear housing 4, and the retainer 41 attachable to and detachable from at least a part of the auxiliary handle 20. The auxiliary pole 40 is held by the retainer 41.

With the above structure, the operator holds the auxiliary handle 20 with the hand to facilitate a smooth drilling operation. The auxiliary pole 40 is supported by the auxiliary handle 20 with the retainer 41. The operator can thus form a hole in the ground with a target depth while holding the auxiliary handle 20 with the hand.

The retainer 41 in the embodiment includes the retention assembly 43 that holds the auxiliary pole 40 in a detachable manner. The retention assembly 43 includes the clamp 44 that at least partially surrounds the auxiliary pole 40 and the lever 46 connected to the clamp 44 with the hinge 45. The auxiliary pole 40 is locked to the clamp 44 in response to the lever 46 being rotated in the fastening direction Ya. The auxiliary pole 40 is unlocked from the clamp 44 in response to the lever 46 being rotated in the release direction Yb.

With the above structure, the auxiliary pole 40 is locked at a vertical position relative to the retainer 41 in response to the lever 46 being rotated in the fastening direction Ya. The auxiliary pole 40 is positionally adjustable in the vertical direction relative to the retainer 41 in response to the lever 46 being rotated in the release direction Yb.

The auxiliary handle 20 in the present embodiment includes the handle joints 21 to be fastened to the gear housing 4, and the handle 22 fastened to the handle joints 21. The retainer 41 is fastened to one of the handle joints 21.

In the above structure, the retainer 41 is fastened to the gear housing 4 with the handle joint 21 in between. The operator can hold the handle 22 with the hand.

The handle joints 21 in the present embodiment include the left handle joint 21L to be fastened to the left portion of the gear housing 4, and the right handle joint 21R to be fastened to the right of the gear housing 4. The retainer 41 is fastened to the right handle joint 21R, and the reaction force receiver 23 is fastened to the left handle joint 21L.

With the above structure, the operator receives a reaction force transmitted from the rotation output unit 5 to the gear housing 4 through the reaction force receiver 23. The posture of the earth auger 1A is thus less likely to be unstable or the operator holding the earth auger 1A is less likely to shake. This allows an intended hole to be formed in the ground. This also reduces interference between the auxiliary pole 40 and the reaction force receiver 23, facilitating a smooth drilling operation.

In the present embodiment, the reaction force receiver 23 may be fastened to the right handle joint 21R, and the retainer 41 may be fastened to the left handle joint 21L.

Each handle joint 21 in the present embodiment has the threaded holes 27. The retainer 41 has the multiple threaded openings 42 at intervals in the front-rear direction. The retainer 41 is fastened to the handle joint 21 with the screws 35 placed in the threaded holes 27 through the corresponding threaded openings 42. The threaded openings 42 to receive the screws 35 are selected to adjust the position of the auxiliary pole 40 in the front-rear direction.

This facilitates positional adjustment of the auxiliary pole 40 in the front-rear direction. The distance between the drill bit 19 and the auxiliary pole 40 is appropriately adjustable in the front-rear direction for the conditions at the work site.

In the present embodiment, the handle 22 on the left (front) of the motor housing 2 may be a first grip grippable by the operator's left hand, and the grip portion 3B on the right (rear) of the motor housing 2 may be a second grip.

With the above structure, the operator, holding the first grip frontward from the rotation output unit 5 and the second grip rearward from the rotation output unit 5, can smoothly perform a drilling operation.

In the present embodiment, the auxiliary pole 40 is attached to the gear housing 4 with the retainer 41. The auxiliary pole 40 may be attached to the motor housing 2 or to the handle housing 3. With the auxiliary pole 40 attached to an appropriate portion of the earth auger 1A, the auxiliary pole 40 is less likely to interfere the drilling operation.

### Second Embodiment

A second embodiment will now be described. The same or corresponding components as those in the above embodiment are given the same reference numerals herein and will be described briefly or will not be described.

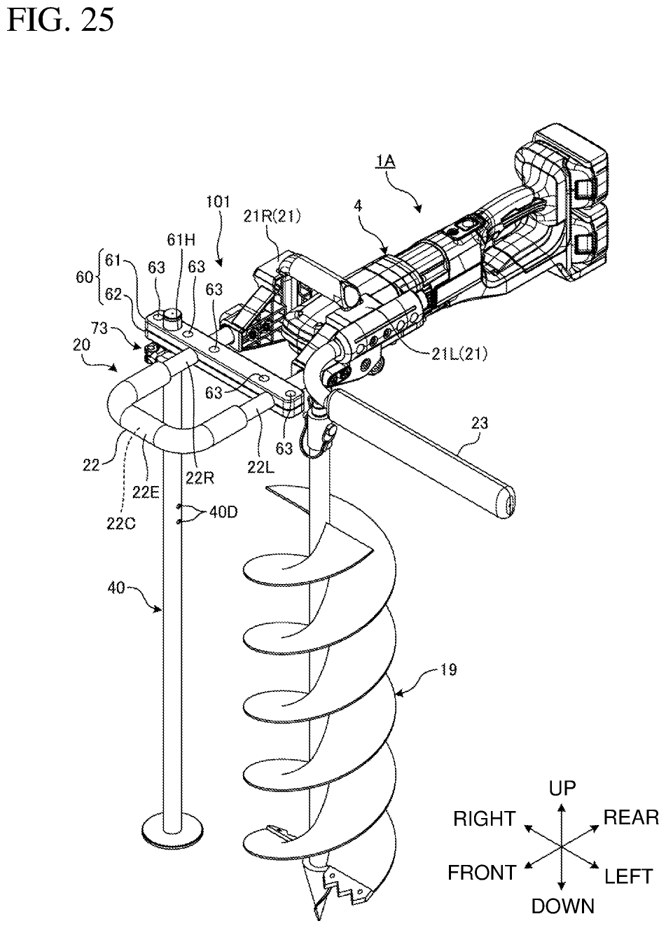

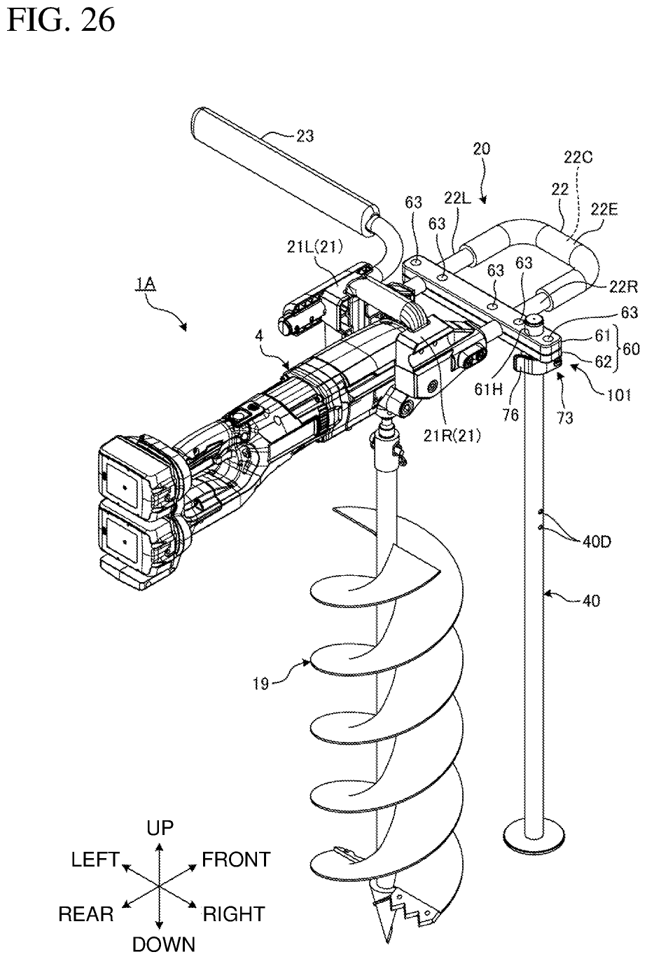

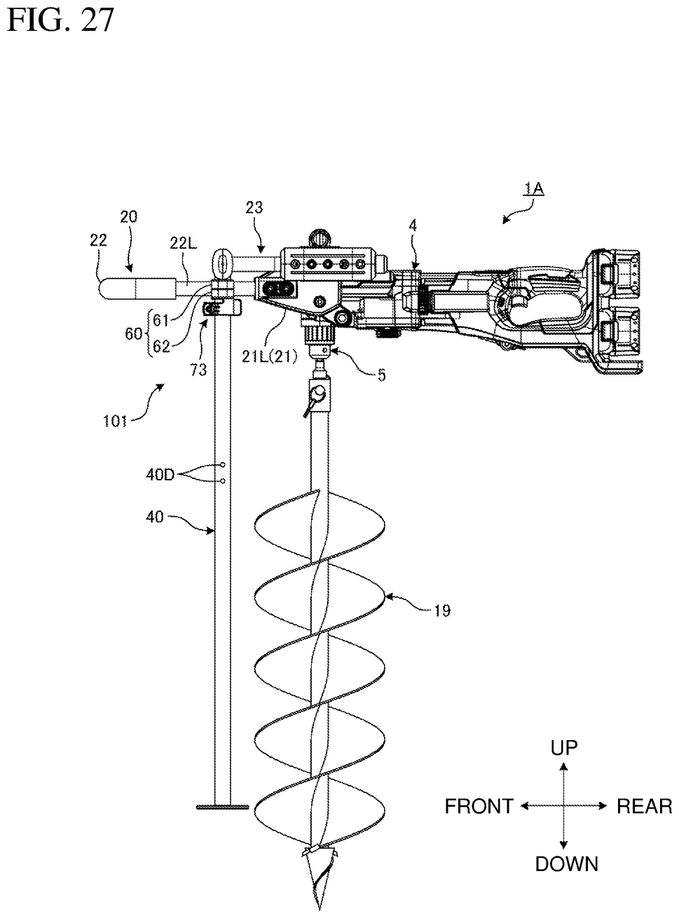

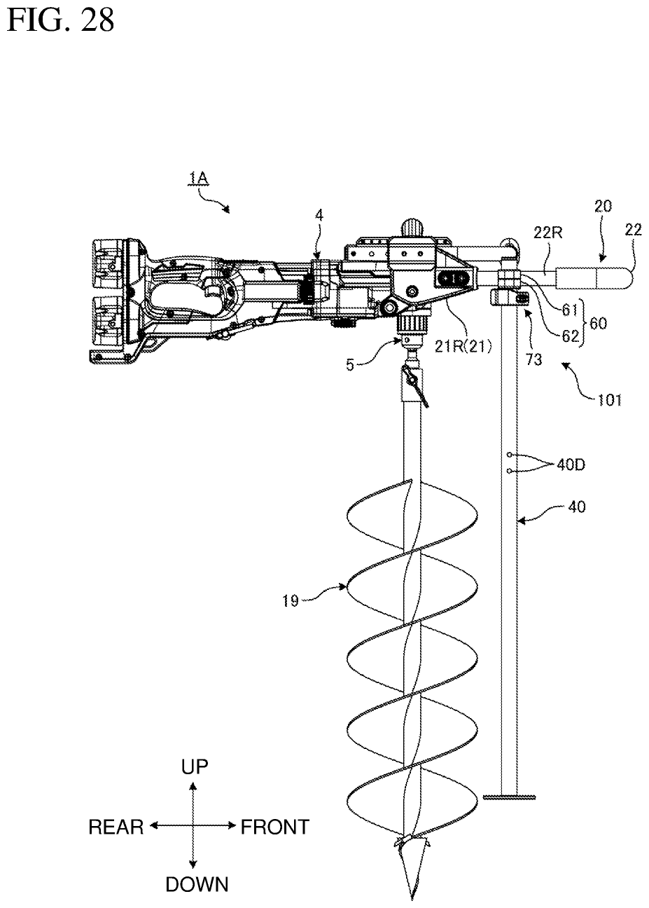

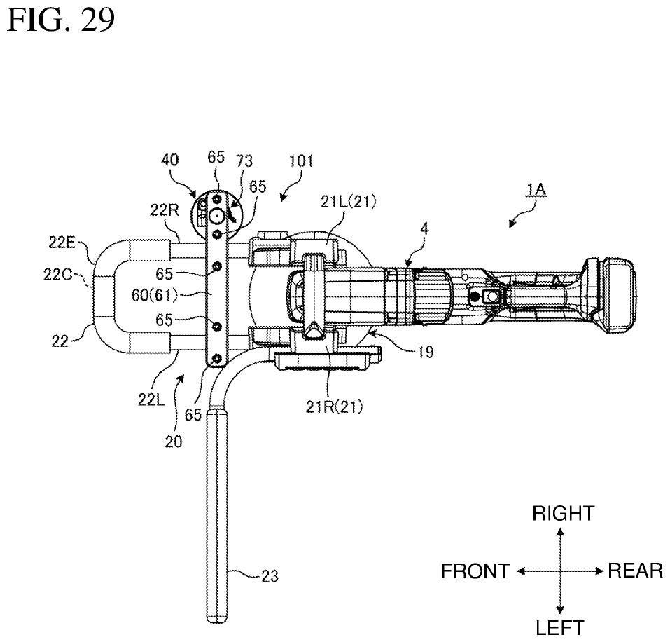

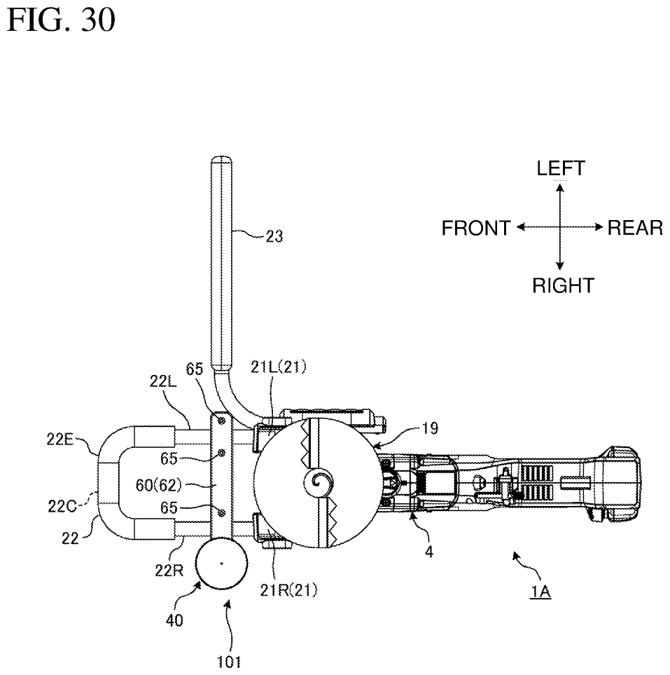

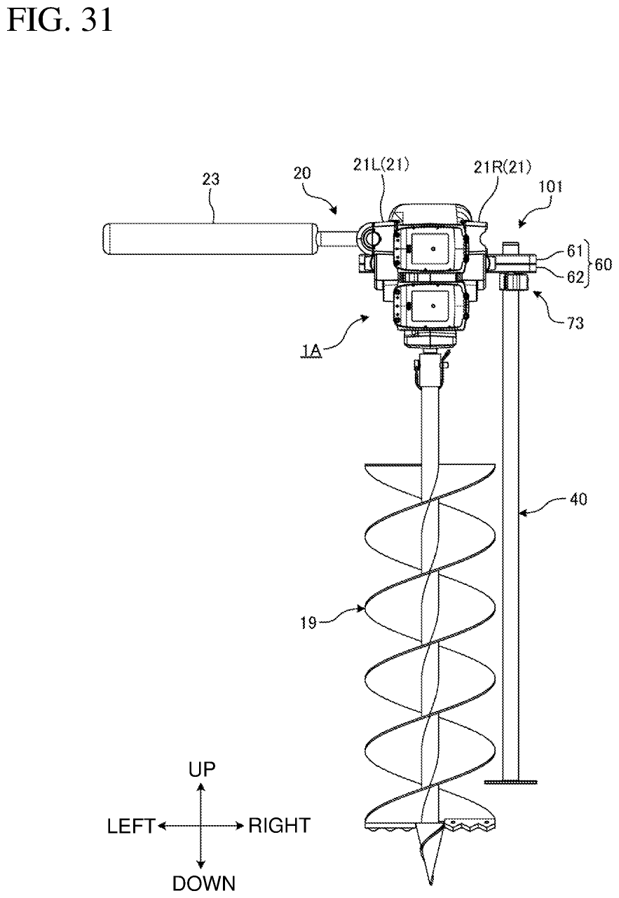

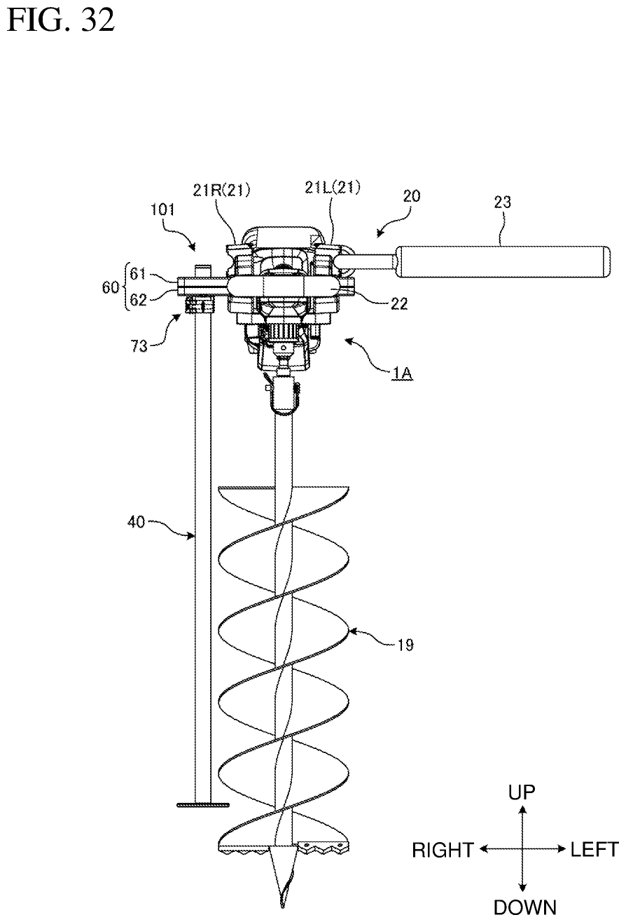

FIG. 25 is a front perspective view of the earth auger 1A with an attachment 101 according to the present embodiment. FIG. 26 is a rear perspective view of the earth auger 1A with the attachment 101 according to the present embodiment. FIG. 27 is a left side view of the earth auger 1A with the attachment 101 according to the present embodiment. FIG. 28 is a right side view of the earth auger 1A with the attachment 101 according to the present embodiment. FIG. 29 is atop view of the earth auger 1A with the attachment 101 according to the present embodiment. FIG. 30 is a bottom view of the earth auger 1A with the attachment 101 according to the present embodiment. FIG. 31 is a rear view of the earth auger 1A with the attachment 101 according to the present embodiment. FIG. 32 is a front view of the earth auger 1A with the attachment 101 according to the present embodiment.

As in the embodiment described above, the attachment 101 includes an auxiliary handle 20. The auxiliary handle 20 includes handle joints 21, a handle 22, and a reaction force receiver 23. The handle joints 21 include a left handle joint 21L and a right handle joint 21R.

As in the embodiment described above, the attachment 101 includes an auxiliary pole 40. The auxiliary pole 40 extends adjacent to the drill bit 19 in the vertical direction. The reaction force receiver 23 is fastened to the left handle joint 21L. In the present embodiment, the retainer 41 is not fastened to the right handle joint 21R.

The attachment 101 includes a retainer 60 attachable to and detachable from at least apart of the auxiliary handle 20. The auxiliary pole 40 is held by the retainer 60. The retainer 60 in the embodiment is fastened to the handle 22. The retainer 60 extends in the lateral direction. The auxiliary pole 40 is supported by the handle 22 with the retainer 60.

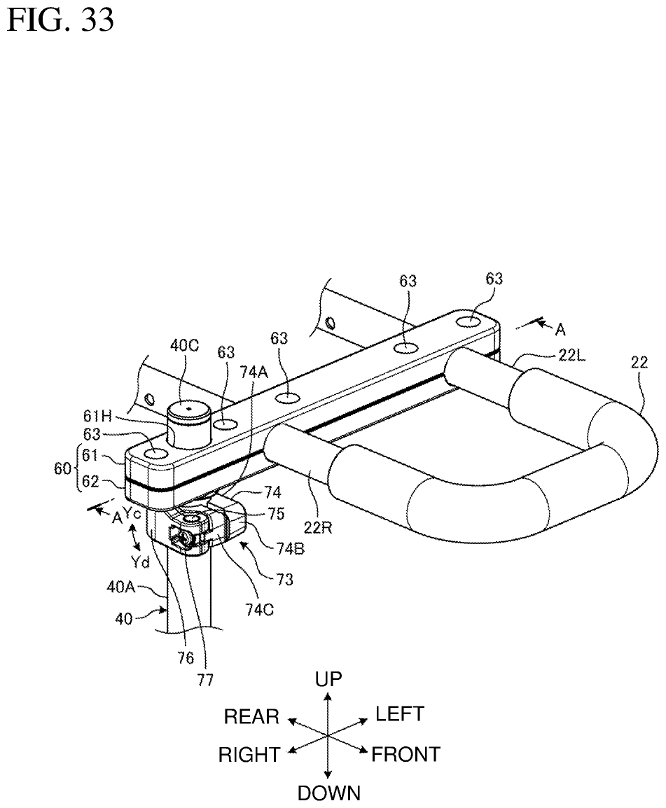

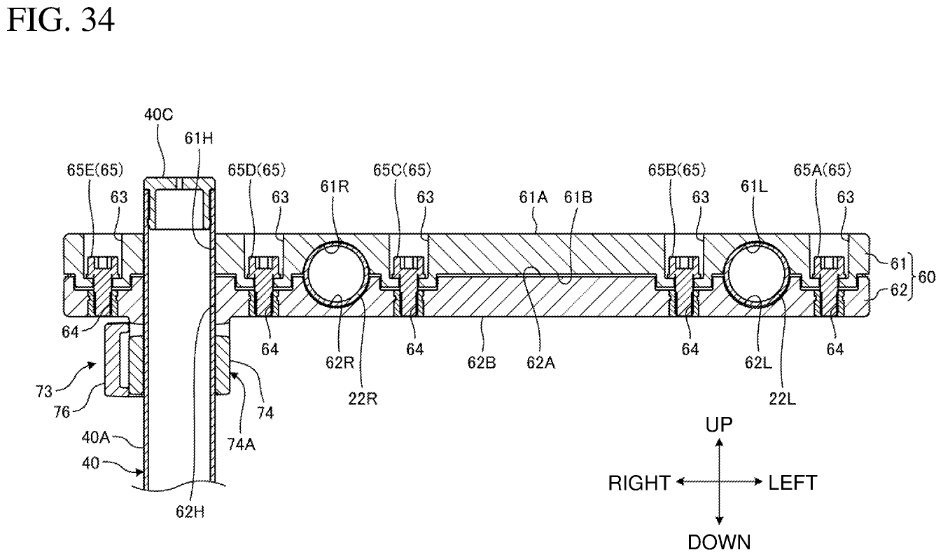

FIG. 33 is a perspective view of the auxiliary pole 40 and the retainer 60 in the present embodiment. FIG. 34 is a cross-sectional view of the auxiliary pole 40 and the retainer 60 in the present embodiment, taken along line A-A in FIG. 33 as viewed in the direction indicated by arrows.

The retainer 60 includes a first retainer portion 61 and a second retainer portion 62. The second retainer portion 62 is located below the first retainer portion 61. The first retainer portion 61 is a plate elongated in the lateral direction. The second retainer portion 62 is a plate elongated in the lateral direction. The first retainer portion 61 has an upper surface 61A and a lower surface 61B. The second retainer portion 62 has an upper surface 62A and a lower surface 62B. The lower surface 61B of the first retainer portion 61 faces the upper surface 62A of the second retainer portion 62. The first retainer portion 61 and the second retainer portion 62 hold the handle 22 between them in the vertical direction.

The retainer 60 is fastened to a left rod 22L and a right rod 22R. The first retainer portion 61 and the second retainer portion 62 hold the left rod 22L and the right rod 22R between them in the vertical direction.

The first retainer portion 61 has recesses 61L and 61R on its lower surface 61B. Each of the recesses 61L and 61R is recessed upward from the lower surface 61B. The recesses 61L and 61R are at an interval in the lateral direction. The recess 61R is rightward from the recess 61L. The recess 61L receives at least a part of the left rod 22L. The recess 61R receives at least a part of the right rod 22R.

The second retainer portion 62 has recesses 62L and 62R on its upper surface 62A. Each of the recesses 62L and 62R is recessed downward from the upper surface 62A. The recesses 62L and 62R are at an interval in the lateral direction. The recess 62R is rightward from the recess 62L. The recess 62L receives at least a part of the left rod 22L. The recess 62R receives at least a part of the right rod 22R.

With an imaginary axis extending in the front-rear direction as a front-rear axis, the inner surface of the recess 61L and the inner surface of the recess 61R each recess upward in an arc from the lower surface 61B in a plane orthogonal to the front-rear axis. The outer surface of the left rod 22L facing the inner surface of the recess 61L and the outer surface of the right rod 22R facing the inner surface of the recess 61R each curve upward in an arc in a plane orthogonal to the front-rear axis. The inner surface of the recess 61L is in contact with the outer surface of the left rod 22L. The inner surface of the recess 61R is in contact with the outer surface of the right rod 22R.

The inner surface of the recess 62L and the inner surface of the recess 62R each recess downward in an arc from the upper surface 62A in a plane orthogonal to the front-rear axis. The outer surface of the left rod 22L facing the inner surface of the recess 62L and the outer surface of the right rod 22R facing the inner surface of the recess 62R each curve downward in an arc in a plane orthogonal to the front-rear axis. The inner surface of the recess 62L is in contact with the outer surface of the left rod 22L. The inner surface of the recess 62R is in contact with the outer surface of the right rod 22R.

The first retainer portion 61 has threaded openings 63. The second retainer portion 62 has threaded holes 64. The screws 65 are placed in the threaded holes 64 through the threaded openings 63. The handle 22 is held between the first retainer portion 61 and the second retainer portion 62. This fastens the first retainer portion 61 and the second retainer portion 62 to the handle 22.

The first retainer portion 61 has a holding hole 61H. A pipe 40A in the auxiliary pole 40 is placed through the holding hole 61H. The second retainer portion 62 has a holding hole 62H. The pipe 40A in the auxiliary pole 40 is placed through the holding hole 62H. The holding hole 61H is rightward from the recess 61R. The holding hole 62H is rightward from the recess 62R.

In the present embodiment, five threaded openings 63 and five threaded holes 64 are at intervals in the lateral direction. Five screws 65 are arranged in the lateral direction. The five screws 65 include a screw 65A, a screw 65B, a screw 65C, a screw 65D, and a screw 65E. The screws 65A and 65B are located on the opposite sides of the left rod 22L in the lateral direction. The screws 65C and 65D are located on the opposite sides of the right rod 22R in the lateral direction. The screws 65D and 65E are located on the opposite sides of the pipe 40A.

The first retainer portion 61 and the second retainer portion 62 fastened with the screws 65 are unfastened from the handle 22 to adjust the position of the retainer 60 and the auxiliary pole 40 held by the retainer 60 in the front-rear direction.

The retainer 60 includes a retention assembly 73 that holds the auxiliary pole 40 in a detachable manner.

The retention assembly 73 includes a clamp 74 and a lever 76. The clamp 74 at least partially surrounds the auxiliary pole 40. The lever 76 is connected to the clamp 74 with a hinge 75.

The clamp 74 can lock the auxiliary pole 40. The clamp 74 is at the lower right end of the second retainer portion 62. The clamp 74 includes an arc 74A, a plate 74B, and a plate 74C. The clamp 74 in the present embodiment is a part of the second retainer portion 62. The arc 74A partially surrounds the pipe 40A. The plate 74B is at one end of the arc 74A. The plate 74C is at the other end of the arc 74A. The plate 74B and the plate 74C face each other across a gap. The plate 74B and the plate 74C are connected together with a screw 77.

The lever 76 is connected to the clamp 74 with the hinge 75. The lever 76 is connected to the clamp 74 with the hinge 75 in a pivotable manner. The operator operates the lever 76 to lock the auxiliary pole 40 with the clamp 74. The lever 76 includes a cam in contact with the plate 74C in the clamp 74. In response to the lever 76 being rotated in a fastening direction Yc indicated by the arrow in FIG. 33, the pipe 40A in the auxiliary pole 40 is tightened to the clamp 74 and the auxiliary pole 40 is locked to the clamp 74. In other words, the auxiliary pole 40 is secured to the right end of the second retainer portion 62. In response to the lever 76 being rotated in a release direction Yd indicated by the arrow in FIG. 33, the auxiliary pole 40 is unlocked. This allows the operator to move the auxiliary pole 40 vertically relative to the clamp 74. The operator can adjust the vertical position of the auxiliary pole 40 relative to the retainer 60.

In the present embodiment, the auxiliary pole 40 is located outward (rightward) from the right handle joint 21R with respect to the middle of the auxiliary handle 20 in the lateral direction, and the reaction force receiver 23 is fastened to the left handle joint 21L.

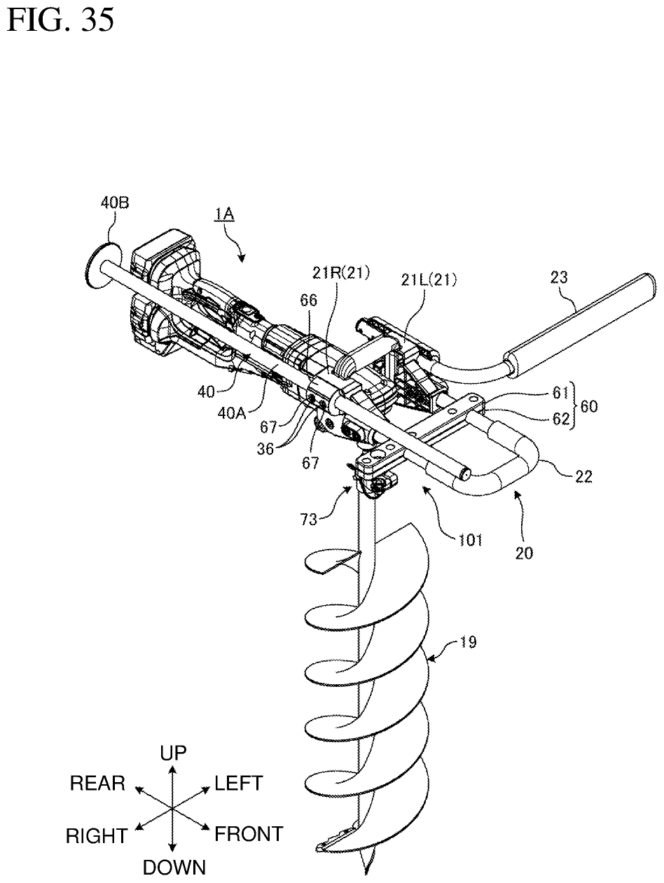

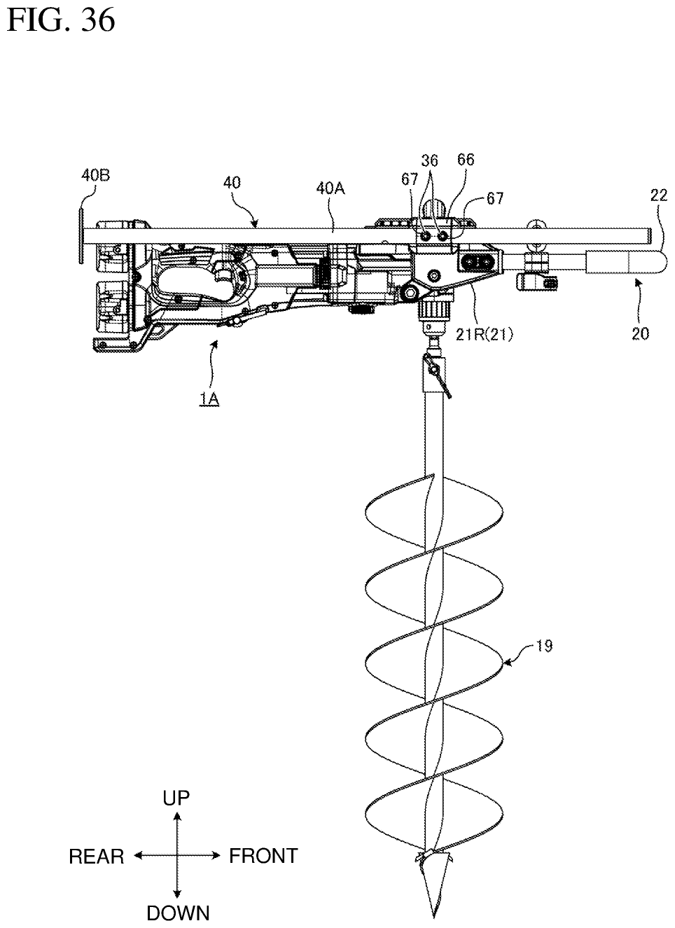

FIG. 35 is a front perspective view of the attachment 101 according to the present embodiment and the earth auger 1A. FIG. 36 is a right side view of the attachment 101 according to the present embodiment and the earth auger 1A.

As described above, the retainer 41 is not fastened to the right handle joint 21R in the present embodiment. In the present embodiment, when the auxiliary pole 40 is not used, the auxiliary pole 40 is fastened to the right handle joint 21R.

As shown in FIGS. 35 and 36, the pipe 40A in the auxiliary pole 40 is received in the outer recess 26 on the right handle joint 21R. The pipe 40A is held between the right handle joint 21R and a cover 66. The cover 66 has threaded openings 67. Two threaded openings 67 are located at an interval in the front-rear direction. As described above, the outer recess 26 has the threaded holes 27 and the pipe 40A has the threaded openings 40D. Screws 36 placed through the threaded openings 67 in the cover 66 and the threaded openings 40D in the pipe 40A are received in the threaded holes 27. The pipe 40A held between the cover 66 and the right handle joint 21R is fastened to the right handle joint 21R with the screw 36.

As described above, the auxiliary handle 20 in the present embodiment includes the handle joints 21 to be fastened to the gear housing 4 and the handle 22 fastened to the handle joints 21. The retainer 60 is fastened to the handle 22.

The retainer 60 is thus fastened to the gear housing 4 with the handle 22 and the handle joint 21 in between.

The retainer 60 in the present embodiment includes the first retainer portion 61 and the second retainer portion 62 below the first retainer portion 61. The first retainer portion 61 and the second retainer portion 62 hold the handle 22 between them in the vertical direction.

This stably fastens the retainer 60 and the handle 22 with the first retainer portion 61 and the second retainer portion 62 holding the handle 22 between them in the vertical direction.

The first retainer portion 61 in the present embodiment has the threaded openings 63. The second retainer portion 62 has the threaded holes 64. The first retainer portion 61, the second retainer portion 62, and the handle 22 are fastened together with the screws 65 placed in the threaded holes 64 through the threaded openings 63.

The screws 65 thus fastens the first retainer portion 61, the second retainer portion 62, and the handle 22 together.

In the present embodiment, the second retainer portion 62 may have the threaded openings 63, and the first retainer portion 61 may have the threaded holes 64.

The handle 22 in the present embodiment extends frontward from the handle joints 21. The first retainer portion 61 and the second retainer portion 62 fastened with the screws 65 are unfastened from the handle 22 to adjust the position of the auxiliary pole 40 in the front-rear direction.

This facilitates positional adjustment of the auxiliary pole 40 in the front-rear direction. The distance between the drill bit 19 and the auxiliary pole 40 is appropriately adjustable in the front-rear direction for the conditions at the work site.

The handle joints 21 in the present embodiment include the left handle joint 21L to be fastened to the left portion of the gear housing 4, and the right handle joint 21R to be fastened to the right of the gear housing 4. The handle 22 includes a left rod 22L extending frontward from the left handle joint 21L, a right rod 22R extending frontward from the right handle joint 21R, and a connecting rod 22C connecting the front end of the left rod 22L and the front end of the right rod 22R. The retainer 60 is fastened to the left rod 22L and the right rod 22R. The auxiliary pole 40 is located outward (rightward) from the right handle joint 21R in the lateral direction, and the reaction force receiver 23 is fastened to the left handle joint 21L.

The retainer 60 is thus fastened to the left rod 22L and the right rod 22R. This stably fastens the retainer 60 and the handle 22 together. The operator receives a reaction force transmitted from the rotation output unit 5 to the gear housing 4 through the reaction force receiver 23. The posture of the earth auger 1A is thus less likely to be unstable or the operator holding the earth auger 1A is less likely to shake. This allows an intended hole to be formed in the ground. This also reduces interference between the auxiliary pole 40 and the reaction force receiver 23, facilitating a smooth drilling operation.

In the present embodiment, the auxiliary pole 40 may be located outward (leftward) from the left handle joint 21L in the lateral direction, and the reaction force receiver 23 may be fastened to the right handle joint 21R.

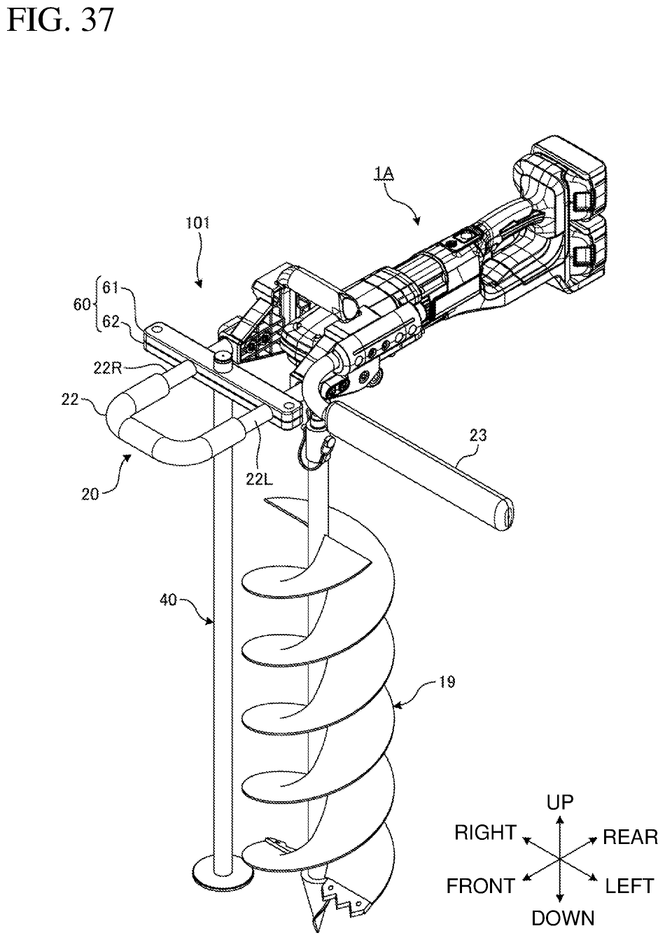

FIG. 37 is a front perspective view of an auxiliary pole 40 and a retainer 60 in a modification of the present embodiment. In the examples shown in FIGS. 25 to 34, the auxiliary pole 40 is located outward from the handle 22 with respect to the middle of the auxiliary handle 20 in the lateral direction. As shown in FIG. 37, the auxiliary pole 40 may be located between the left rod 22L and the right rod 22R in the lateral direction.

### Third Embodiment

A third embodiment will now be described. The same or corresponding components as those in the above embodiment are given the same reference numerals herein and will be described briefly or will not be described.

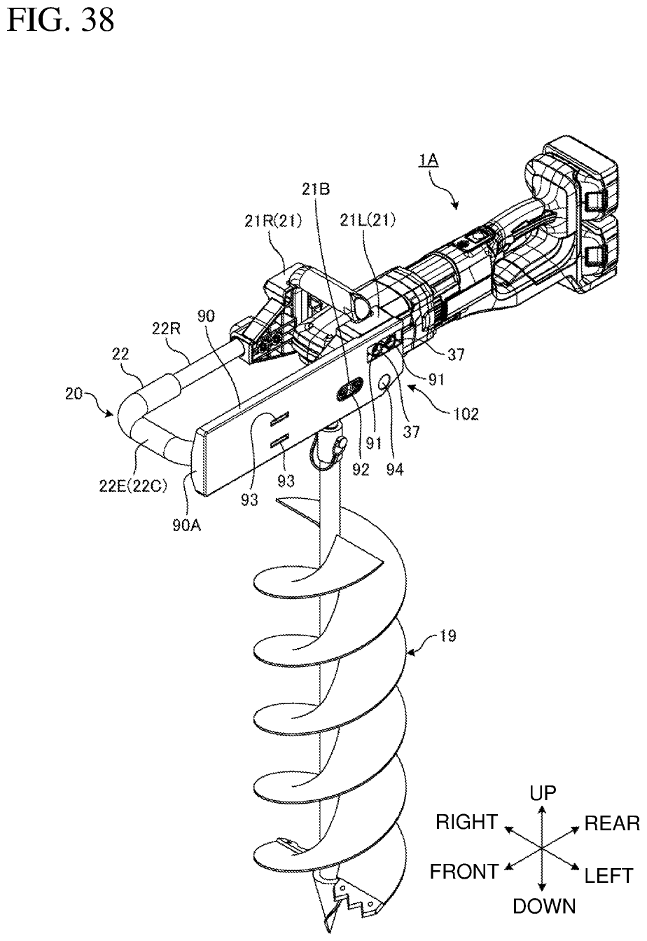

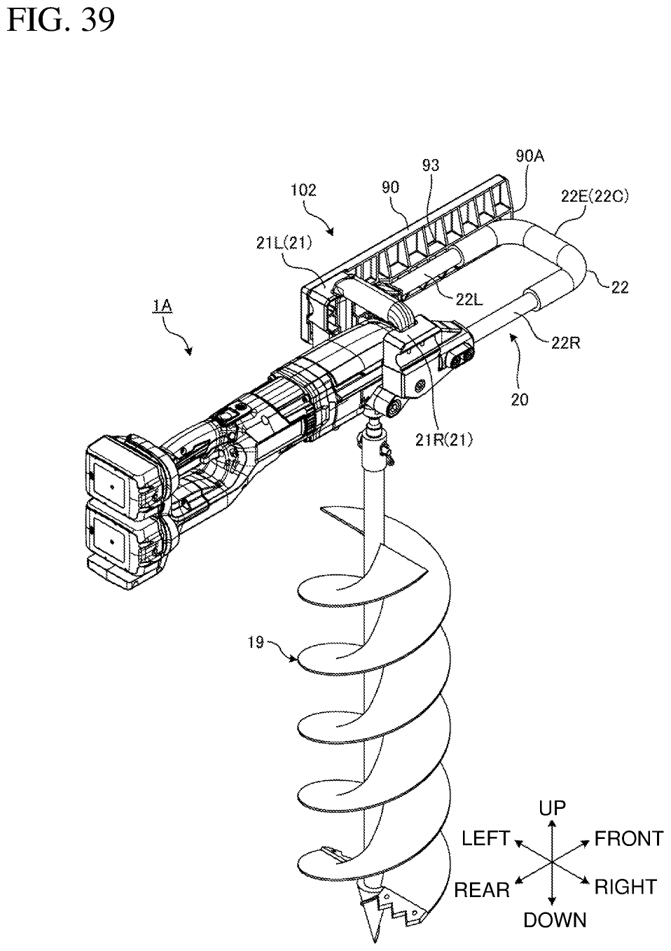

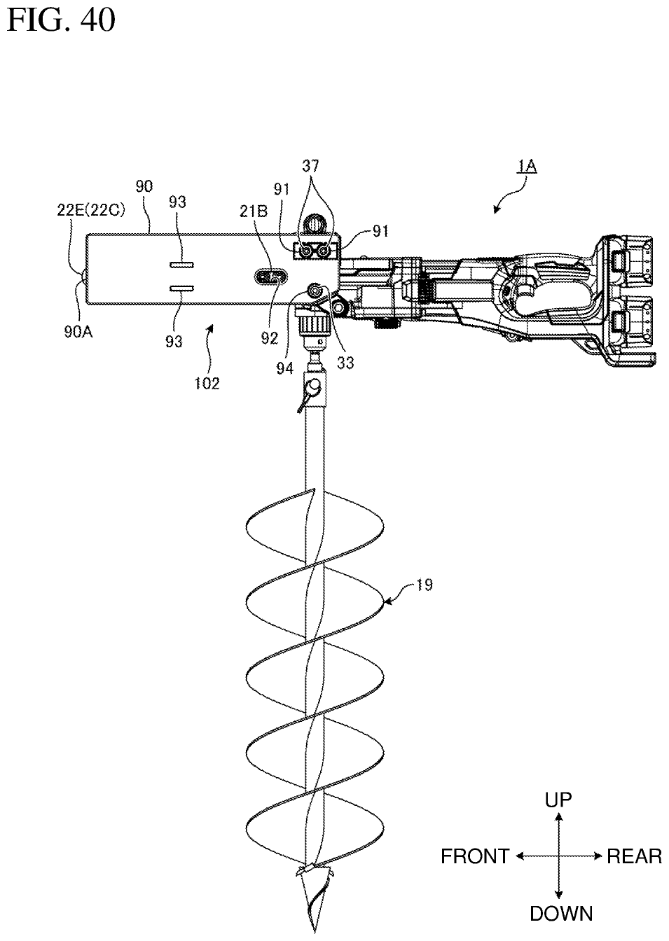

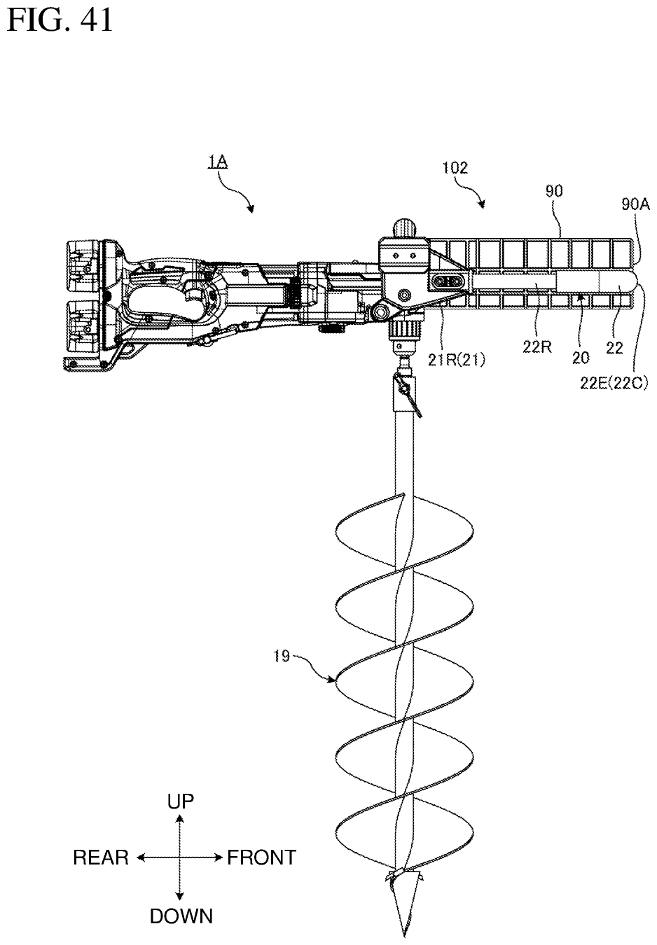

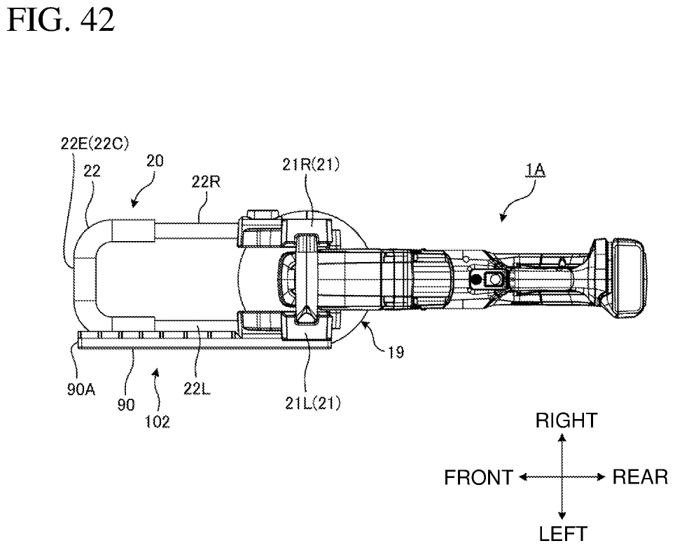

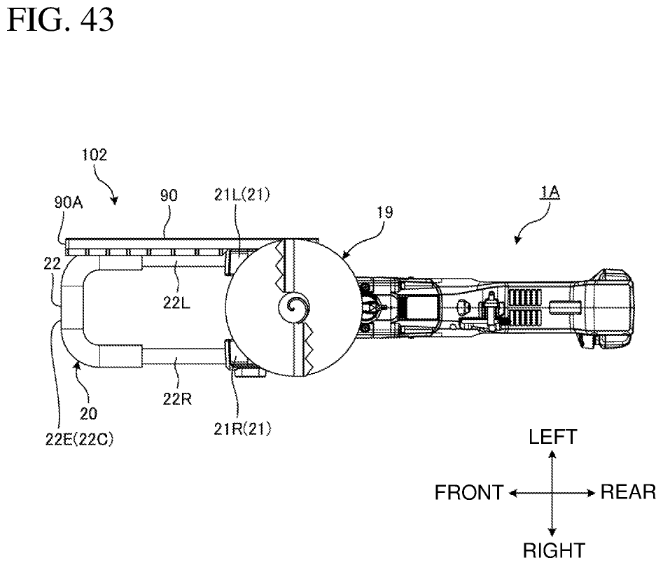

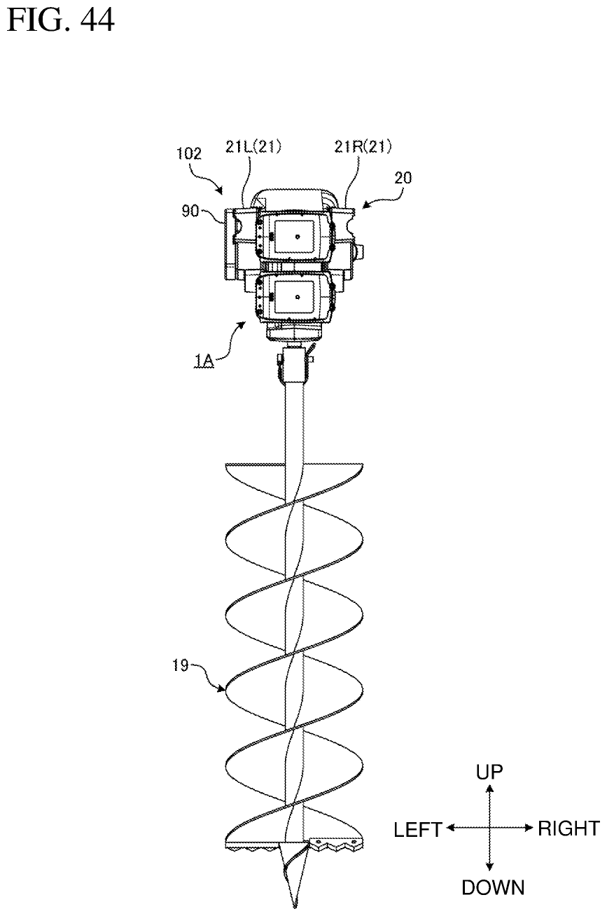

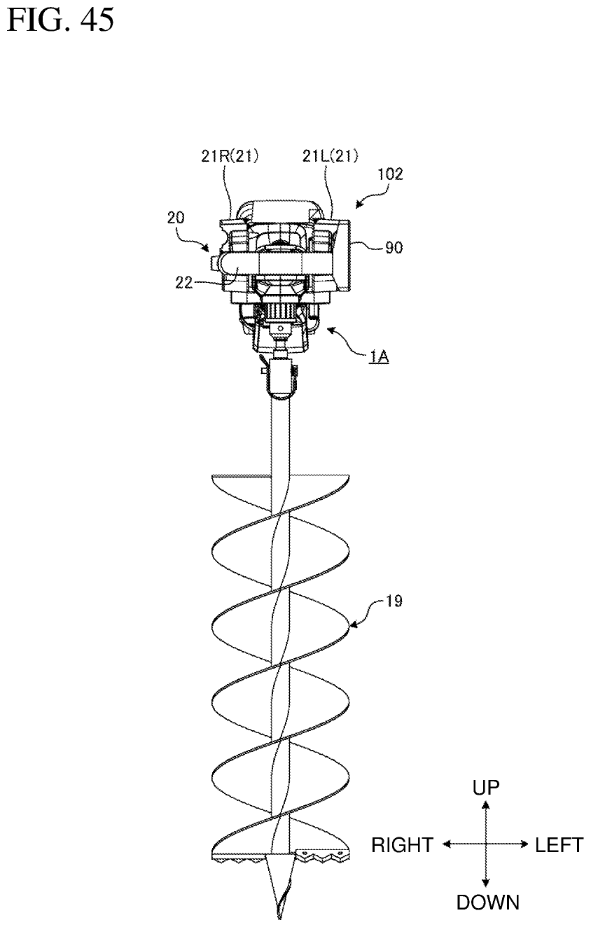

FIG. 38 is a front perspective view of the earth auger 1A with an attachment 102 according to the present embodiment. FIG. 39 is a rear perspective view of the earth auger 1A with the attachment 102 according to the present embodiment. FIG. 40 is a left side view of the earth auger 1A with the attachment 102 according to the present embodiment. FIG. 41 is a right side view of the earth auger 1A with the attachment 102 according to the present embodiment. FIG. 42 is atop view of the earth auger 1A with the attachment 102 according to the present embodiment. FIG. 43 is a bottom view of the earth auger 1A with the attachment 102 according to the present embodiment. FIG. 44 is a rear view of the earth auger 1A with the attachment 102 according to the present embodiment. FIG. 45 is a front view of the earth auger 1A with the attachment 102 according to the present embodiment.

The attachment 102 includes an auxiliary handle 20. The auxiliary handle 20 in the present embodiment includes handle joints 21 including a left handle joint 21L and a right handle joint 21R, and a handle 22 as described with reference to FIGS. 9 and 10. The auxiliary handle 20 in the present embodiment does not include the reaction force receiver 23.

As in the embodiments described above, the attachment 102 includes an auxiliary pole 40. The auxiliary pole 40 extends adjacent to the drill bit 19 in the vertical direction. The reaction force receiver 23 is fastened to the left handle joint 21L. In the present embodiment, a retainer 41 is not fastened to the right handle joint 21R.

The attachment 102 includes an auxiliary plate 90. The auxiliary plate 90 is located on the left of the gear housing 4. The auxiliary plate 9) receives a reaction force transmitted from the rotation output unit 5 to the gear housing 4. The auxiliary plate 90 is fastened to at least a part of the auxiliary handle 20.

The auxiliary plate 90 in the present embodiment is fastened to the left handle joint 21L. The auxiliary plate 90 has threaded openings 91. Two threaded openings 91 are located at an interval in the front-rear direction. As described above, the left handle joint 21L has threaded holes 27 in an outer recess 26. Screws 37 are placed in the threaded holes 27 through the threaded openings 91, fastening the auxiliary plate 90 to the left handle joint 21L.

The auxiliary plate 90 has an opening 92, slits 93, and an opening 94. A screw boss 21B is received in the opening 92. The slits 93 are located frontward from the opening 92. The opening 94 is located rearward from the opening 92.

The screw boss 21B in the opening 92 positions the auxiliary plate 90 relative to the left handle joint 21L. In the present embodiment, the screw boss 21B and the opening 92 serve as a positioner for positioning the auxiliary plate 90 relative to the left handle joint 21L.

Two slits 93 are located in the vertical direction. For example, a cable tie connected to the left rod 22L is placed through the slits 93. The cable tie fastens the left rod 22L and the front of the auxiliary plate 90 together.

The opening 94 is aligned with a screw 33.

With the auxiliary plate 90 fastened to the left handle joint 21L, the auxiliary plate 90 has a front end 90A located frontward from the front end of the gear housing 4. The front end 90A of the auxiliary plate 90 is located rearward from the front end of the connecting rod 22C (cover 22E), which is the front end of the handle 22. The auxiliary plate 90 has its upper end located above the upper end of the handle 22 and above the upper end of the left handle joint 21L. The auxiliary plate 90 has its lower end located below the lower end of the handle 22.

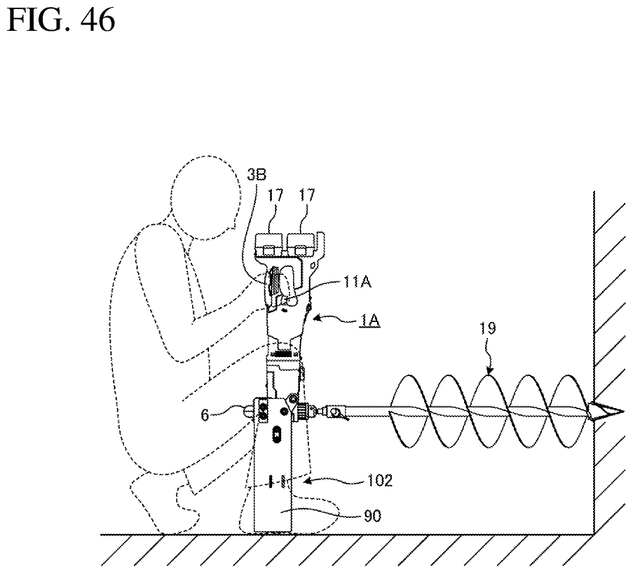

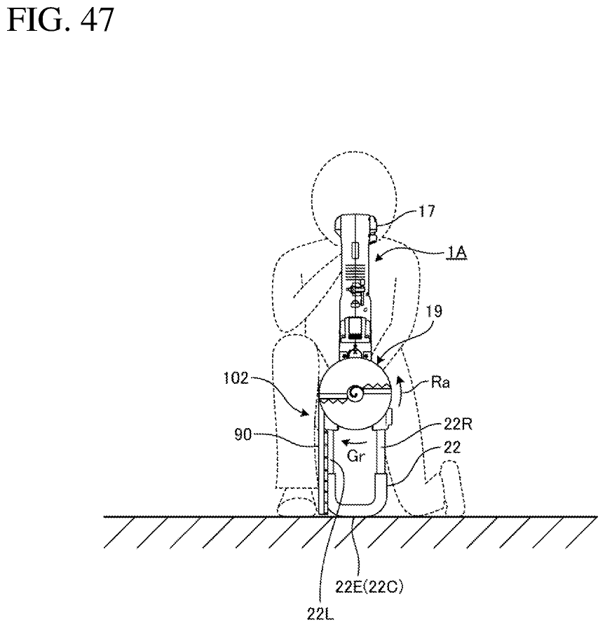

FIG. 46 is a side view of the earth auger 1A according to the present embodiment, describing its use. FIG. 47 is a front view of the earth auger 1A according to the present embodiment, describing its use. In the present embodiment, the drill target of the earth auger 1A is an earthen wall. The earth auger 1A with the attachment 102 is used to form a hole horizontally in the earthen wall. To form a hole, the earth auger 1A is positioned with the front end of the handle 22, which is the connecting rod 22C (cover 22E), in contact with the ground.

The operator holds the front grip 6 with the left hand and the grip portion 3B in the handle housing 3 with the right hand. The operator places the auxiliary plate 90 into contact with the right leg. The operator performs a drilling operation in a squatting position to place the auxiliary plate 90 into contact with at least part of the inner thigh, inner knee, or inner lower leg of the right leg.

The operator operates the trigger lever 11A with a finger of the right hand holding the grip portion 3B. This causes the rotation output unit 5 to rotate in a predetermined direction Ra indicated by the arrow in FIG. 47, with the drill bit 19 being attached.

The operator pushes the earth auger 1A forward and presses the rotating drill bit 19 against the earthen wall. This causes the earth auger 1A to drill the earthen wall to forma hole in the earthen wall.

In drilling the earthen wall, a large reaction force Gr may act on the gear housing 4 through the drill bit 19 and the rotation output unit 5 in a direction opposite to the predetermined direction Ra indicated by the arrow in FIG. 47.

In drilling the earthen wall, when the drill bit 19 strikes a hard foreign object such as a rock, an excess reaction force may suddenly act on the gear housing 4. When the gear housing 4 receives a large reaction force, the posture of the earth auger 1A may be unstable or the operator holding the earth auger 1A may shake. This may cause difficulty in drilling an intended hole in the earthen wall.

In the present embodiment, the auxiliary plate 90 is attached to the earth auger 1A with the auxiliary handle 20 in between to receive a reaction force transmitted from the rotation output unit 5 to the gear housing 4.

The auxiliary plate 90 is held by the operator's right leg and receives the reaction force Gr in the rotation direction of the rotation output unit 5. When the gear housing 4 receives the large reaction force Gr, the posture of the earth auger 1A is less likely to be unstable or the operator holding the earth auger 1A is less likely to shake.

At the end of the drilling operation, the operator can pull the earth auger 1A toward the operator by holding at least one of the handle 22, the grip portion 3B, or the front grip 6 with the hand. This removes the drill bit 19 from the hole in the earthen wall.

As described above, the attachment 102 in the present embodiment includes the auxiliary plate 90 to be located on the left of the gear housing 4 to receive a reaction force transmitted from the rotation output unit 5 to the gear housing 4.

The auxiliary plate 90 thus assists the drilling operation in forming an intended hole in the earthen wall, which is a drill target. The operator receives the reaction force Gr transmitted from the rotation output unit 5 to the gear housing 4 through the auxiliary plate 90. The posture of the earth auger 1A is thus less likely to be unstable or the operator holding the earth auger 1A is less likely to shake. This allows the intended hole to be formed in the earthen wall.

The auxiliary plate 90 in the embodiment has the front end 90A to be located frontward from the front end of the gear housing 4.

With the above structure, the auxiliary plate 90 has a larger profile than the gear housing 4. This structure allows the operator to receive the reaction force Gr transmitted from the rotation output unit 5 to the gear housing 4 through the auxiliary plate 90.

The attachment 102 according to the present embodiment includes the auxiliary handle 20 attachable to and detachable from the gear housing 4. The auxiliary plate 90 is fastened to at least a part of the auxiliary handle 20. The auxiliary handle 20 includes the left handle joint 21L to be fastened to the left portion of the gear housing 4, the right handle joint 21R to be fastened to the right portion of the gear housing 4, and the handle 22 fastened to the handle joints 21. The auxiliary plate 90 is fastened to the left handle joint 21L.

With the above structure, the operator holds the auxiliary handle 20 with the hand to facilitate a smooth drilling operation. The auxiliary handle 20 assists the drilling operation in forming an intended hole in the earthen wall. The auxiliary plate 90 is fastened to the left handle joint 21L. This structure allows the operator to receive the reaction force Gr transmitted from the rotation output unit 5 to the gear housing 4 through the auxiliary handle 20 and the auxiliary plate 90.

The auxiliary plate 90 in the present embodiment may be fastened to the right handle joint 21R, or the auxiliary plates 90 may be fastened to both the left and right handle joints 21L and 21R.

In the present embodiment, the handle 22 on the left (front) of the motor housing 2 may be a first grip grippable by the operator's left hand, and the grip portion 3B on the right (rear) of the motor housing 2 may be a second grip.

The auxiliary plate 90 in the present embodiment is attached to the gear housing 4 with the auxiliary handle 20 in between. The auxiliary plate 90 may be attached to the motor housing 2 or to the handle housing 3. With the auxiliary plate 90 attached to an appropriate portion of the earth auger 1A, the operator can receive a reaction force through the auxiliary plate 90.

### Fourth Embodiment

A fourth embodiment will now be described. The same or corresponding components as those in the above embodiment are given the same reference numerals herein and will be described briefly or will not be described.

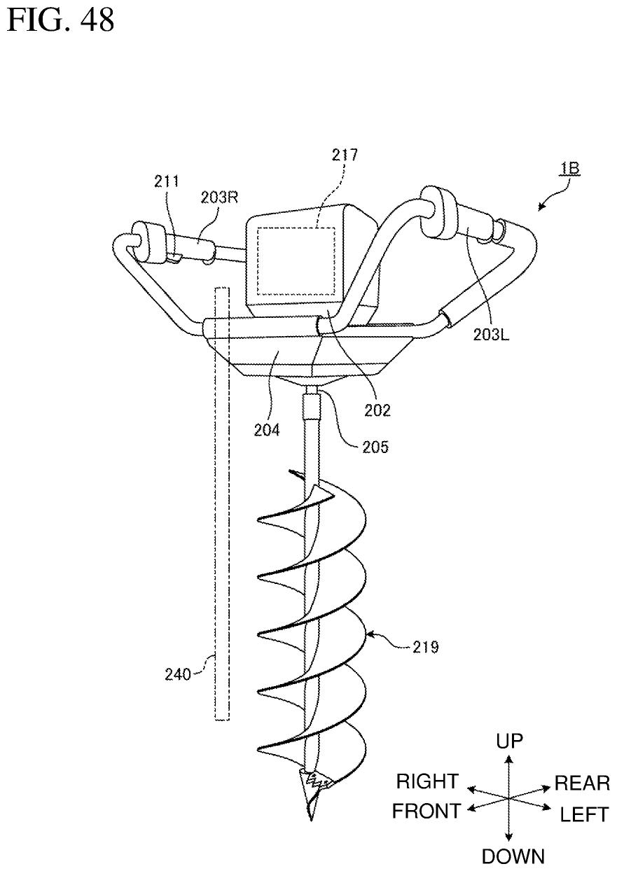

FIG. 48 is a front perspective view of an earth auger 1B according to the present embodiment. The earth auger 1B includes a motor housing 202, a first grip 203L, a second grip 203R, a trigger switch 211, a gear housing 204, a rotation output unit 205, and an auxiliary pole 240.

The motor housing 202 accommodates a motor. The motor housing 202 also accommodates a battery 217.

The first grip 203L is on the left of the motor housing 202. The second grip 203R is on the right of the motor housing 202. The trigger switch 211 is operable to activate the motor. The trigger switch 211 is located on the second grip 203R.

The gear housing 204 is connected to a lower portion of the motor housing 202. The gear housing 204 accommodates a gear.

The rotation output unit 205 protrudes downward from the gear housing 204. The rotation output unit 205 receives a drill bit 219.

The auxiliary pole 240 extends adjacent to the drill bit 219 in the vertical direction. The auxiliary pole 240 has the same function as the auxiliary pole 40 described in the above first and second embodiments. The auxiliary pole 240 on the left or right of the rotation output unit 205 is movable in the vertical direction and is fastened at a predetermined position in the vertical direction. The auxiliary pole 240 is attached to at least one of the motor housing 202 or the gear housing 204. The auxiliary pole 240 may be held by a retainer attached to at least one of the motor housing 202 or the gear housing 204.

### Fifth Embodiment

A fifth embodiment will now be described. The same or corresponding components as those in the above embodiment are given the same reference numerals herein and will be described briefly or will not be described.

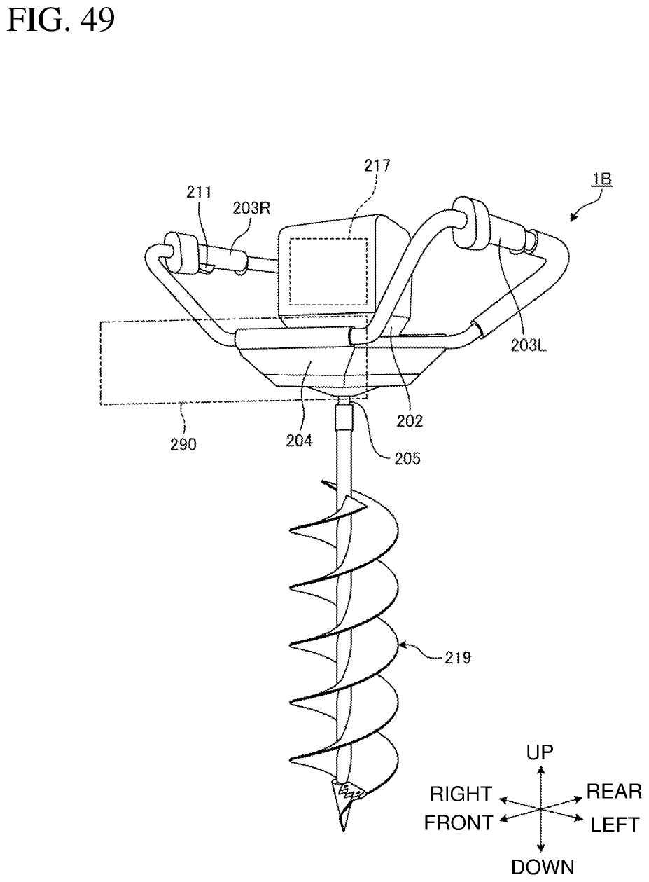

FIG. 49 is a front perspective view of the earth auger 1B according to the present embodiment. As in the fourth embodiment described above, the earth auger 1B includes a motor housing 202, a first grip 203L, a second grip 203R, a trigger switch 211, a gear housing 204, and a rotation output unit 205.

The earth auger 1B includes an auxiliary plate 290. The auxiliary plate 290 has the same function as the auxiliary plate 90 described in the above third embodiment. The auxiliary plate 290 is attached to at least one of the motor housing 202 or the gear housing 204. The auxiliary plate 290 receives a reaction force generated by the rotation of the rotation output unit 205 with the operator's body.

The auxiliary plate 290 thus assists the drilling operation in forming an intended hole in a drill target. The operator receives a reaction force transmitted from the rotation output unit 205 to the gear housing 204 through the auxiliary plate 290. The posture of the earth auger 1B is thus less likely to be unstable or the operator holding the earth auger 1B is less likely to shake. This allows the intended hole to be formed in the drill target.

### REFERENCE SIGNS LIST

1A earth auger
1B earth auger
2 motor housing
2E outlet
3 handle housing
3A front portion
3B grip portion
3C controller compartment
3D battery connector
4 gear housing
4A cover
5 rotation output unit
5A adapter
5B fastener
6 front grip
6C threaded opening
6H bridge
6L left arm
6R right arm
7 battery mount
8 motor
9 forward-reverse switch lever
10 main switch
11 trigger switch
11A trigger lever
11B switch circuit
13 controller
14 reducer
15 speed switch lever
16 threaded hole
17 battery pack
17C release button
18 threaded hole
19 drill bit
19A drill shaft
19B drill blade
19C tip bit
19D cutting bit
19U lower end
20 auxiliary handle
21 handle joint
21A body
21B screw boss
21C screw boss
21L left handle joint
21R right handle joint
22 handle
22L left rod
22R right rod
22C connecting rod
22E cover
23 reaction force receiver
23A fixing rod
23B extension rod
23C cover
23D cover
23E threaded opening
24 handle hole
25 inner recess
26 outer recess
27 threaded hole
28 threaded opening
29 threaded opening
30 threaded opening
31 screw
32 screw
33 screw
34 screw
35 screw
36 screw
37 screw
40 auxiliary pole
40A pipe
40B leg
40C cap
40D threaded opening
40E plug
40F flange
40U lower end
41 retainer
42 threaded opening
43 retention assembly
44 clamp
44A arc
44B plate
44C plate
45 hinge
46 lever
47 screw
51 spindle
52 drill chuck
52A insertion hole
53 needle bearing
54 ball bearing
55 bevel gear
60 retainer
61 first retainer portion
61A upper surface
61B lower surface
61H holding hole
61L recess
61R recess
62 second retainer portion
62A upper surface
62B lower surface
62H holding hole
62L recess
62R recess
63 threaded opening
64 threaded hole
65 screw
65A screw
65B screw
65C screw
65D screw
65E screw
66 cover
67 threaded opening
73 retention assembly
74 clamp
74A arc
74B plate
74C plate
75 hinge
76 lever
77 screw
81 stator
81A stator core
81B front insulator
81C rear insulator
81D coil
81E sensor circuit board
81F connection wire
82 rotor
82A rotor shaft
82B rotor core
82C permanent magnet
83 bearing
84 bearing
85 centrifugal fan
90 auxiliary plate
90A front end
91 threaded opening
92 opening
93 slit
94 opening
100 attachment
101 attachment
102 attachment
141 first planetary gear assembly
141C first carrier
141P planetary gear
141R internal gear
141S pinion gear
142 second planetary gear assembly
142C second carrier
142P planetary gear
142R internal gear
142S sun gear
143 countershaft
144 output shaft
145 support pin
146 support pin
147 bearing
148 bevel gear
150 switching member
150H hole
151 connector
151H hole
202 motor housing
203L first grip
203R second grip
204 gear housing
205 rotation output unit
211 trigger switch
217 battery
219 drill bit
240 auxiliary pole
290 auxiliary plate
AX rotation axis
BX rotation axis
Gr reaction force
Hr reaction force
Ra predetermined direction
Vr reaction force
Ya fastening direction
Yb release direction
Yc fastening direction
Yd release direction
AD distance

What is claimed is:

1. An attachment attachable to an earth auger, the earth auger including
a motor housing accommodating a motor,
a handle housing behind the motor housing, the handle housing including a grip portion receiving a trigger switch operable to activate the motor,
a gear housing in front of the motor housing, the gear housing accommodating a gear, and
a rotation output unit protruding downward from the gear housing to receive a drill bit, the attachment comprising:
an auxiliary pole to be located adjacent to the drill bit and extendable in a vertical direction.

2. The attachment according to claim 1, wherein
the auxiliary pole has a lower end to be located above a lower end of the drill bit.

3. The attachment according to claim 1, further comprising:
an auxiliary handle attachable to and detachable from the gear housing; and
a retainer attachable to and detachable from at least a part of the auxiliary handle,
wherein the auxiliary pole is held by the retainer.

4. The attachment according to claim 3, wherein
the retainer includes a retention assembly configured to hold the auxiliary pole in a detachable manner,
the retention assembly includes
a clamp configured to at least partially surround the auxiliary pole, and
a lever connected to the clamp with a hinge, and
the auxiliary pole is locked to the clamp in response to the lever being rotated in a fastening direction, and is unlocked from the clamp in response to the lever being rotated in a release direction.

5. The attachment according to claim 3, wherein
the auxiliary handle includes
a handle joint to be fastened to the gear housing, and
a handle fastened to the handle joint, and
the retainer is fastened to the handle joint.

6. The attachment according to claim 5, wherein
the handle joint includes
a left handle joint to be fastened to a left portion of the gear housing, and
a right handle joint to be fastened to a right portion of the gear housing, and
the retainer is fastened to one of the left handle joint or the right handle joint included in the handle joint, and a reaction force receiver is fastened to another one of the left handle joint or the right handle joint included in the handle joint.

7. The attachment according to claim 6, wherein
the handle joint has a threaded hole,
the retainer has a plurality of threaded openings at intervals in a front-rear direction,
the retainer is fastened to the handle joint with a screw placed in the threaded hole through a threaded opening of the plurality of threaded openings, and
the threaded opening of the plurality of threaded openings to receive the screw is selected to adjust a position of the auxiliary pole in the front-rear direction.

8. The attachment according to claim 3, wherein
the auxiliary handle includes
a handle joint to be fastened to the gear housing, and
a handle fastened to the handle joint, and
the retainer is fastened to the handle.

9. The attachment according to claim 8, wherein
the retainer includes
a first retainer portion, and
a second retainer portion below the first retainer portion, and
the first retainer portion and the second retainer portion hold the handle in between in the vertical direction.

10. The attachment according to claim 9, wherein
one of the first retainer portion or the second retainer portion has a threaded opening,
another one of the first retainer portion or the second retainer portion has a threaded hole, and
the first retainer portion, the second retainer portion, and the handle are fastened together with a screw placed in the threaded hole through the threaded opening.

11. The attachment according to claim 10, wherein
the handle extends frontward from the handle joint, and
the first retainer portion and the second retainer portion fastened with the screw are unfastened from the handle to adjust a position of the auxiliary pole in the front-rear direction.

12. The attachment according to claim 8, wherein
the handle joint includes
a left handle joint to be fastened to a left portion of the gear housing, and
a right handle joint to be fastened to a right portion of the gear housing,
the handle includes
a left rod extending frontward from the left handle joint,
a right rod extending frontward from the right handle joint, and
a connecting rod connecting a front end of the left rod and a front end of the right rod,
the retainer is fastened to the left rod and the right rod, and
the auxiliary pole is located outward from one of the left handle joint or the right handle joint in a lateral direction, and a reaction force receiver is fastened to another one of the left handle joint or the right handle joint.

13. An attachment attachable to an earth auger, the earth auger including
a motor housing accommodating a motor,
a handle housing behind the motor housing, the handle housing including a grip portion receiving a trigger switch operable to activate the motor,
a gear housing in front of the motor housing, the gear housing accommodating a gear, and
a rotation output unit protruding downward from the gear housing to receive a drill bit, the attachment comprising:
an auxiliary plate to be located on at least one of a left or a right of the gear housing to receive a reaction force transmitted from the rotation output unit to the gear housing.

14. The attachment according to claim 13, wherein
the auxiliary plate has a front end to be located frontward from a front end of the gear housing.

15. The attachment according to claim 14, further comprising:
an auxiliary handle attachable to and detachable from the gear housing,
wherein the auxiliary plate is fastened to at least a part of the auxiliary handle,
the auxiliary handle includes
a left handle joint to be fastened to a left portion of the gear housing,
a right handle joint to be fastened to a right portion of the gear housing, and
a handle fastened to the left handle joint and the right handle joint, and
the auxiliary plate is fastened to one of the left handle joint or the right handle joint.

16. An earth auger, comprising:
a motor housing accommodating a motor;
a handle housing behind the motor housing, the handle housing including a grip portion receiving a trigger switch;
a gear housing in front of the motor housing, the gear housing accommodating a gear;
a rotation output unit protruding downward from the gear housing to receive a drill bit; and
the attachment according to claim 1.

17. An earth auger, comprising:
a motor housing accommodating a motor;
a first grip on a left of the motor housing;
a second grip on a right of the motor housing;
a trigger switch operable to activate the motor;
a gear housing connected to the motor housing, the gear housing accommodating a gear;
a rotation output unit protruding downward from the gear housing to receive a drill bit; and
an auxiliary plate attached to at least one of the motor housing or the gear housing to receive a reaction force generated by rotation of the rotation output unit with an operator's body.

18. The attachment according to claim 2, further comprising:
an auxiliary handle attachable to and detachable from the gear housing; and
a retainer attachable to and detachable from at least a part of the auxiliary handle,
wherein the auxiliary pole is held by the retainer.

19. The attachment according to claim 4, wherein
the auxiliary handle includes
a handle joint to be fastened to the gear housing, and
a handle fastened to the handle joint, and
the retainer is fastened to the handle joint.

20. The attachment according to claim 4, wherein
the auxiliary handle includes
a handle joint to be fastened to the gear housing, and
a handle fastened to the handle joint, and
the retainer is fastened to the handle.
